(19) United States
(12) Patent Application Publication
(10) Pub. No.: US 2002/0091767 A1
(43) Pub. Date: Jul. 11, 2002

(54) Sponsorship management system

(76) Inventor: Michael J. Munson, Cupertino, CA (US)

Correspondence Address: Thomas N. Giaccherini, Anglin & Giaccherini, Post Office Box 1146, Carmel Valley, CA, 93924, US

(21) Appl. No.: 09/758,012

(22) Filed: Jan. 10, 2001

(51) Int. Cl. G06F 15/16; G09G 5/00

(52) U.S. Cl. 709/204; 709/218; 345/751

(57) ABSTRACT

The present invention comprises methods and apparatus for creating a new marketplace for the sponsorship industry. In one embodiment of the invention, a website allows users to view information concerning a multiple listing of events that may be sponsored. Requests for sponsorship proposals (RFPs) are received from buyers, and displayed to sellers on the website. Sellers may then respond to an RFP by completing a form displayed on the site. Additional information may be obtained by either party, and the site may be used to secure a transaction between the parties. In another embodiment of the invention, the website offers a corporate management tool which may be employed to organize information about the sponsorship of events.

### BACKGROUND OF THE INVENTION

Corporations spend hundreds of billions of dollars annually to promote their products and services to their customers. Many large U.S. companies spend tens of billions of dollars every year to market their wares. In addition to the advertising campaigns that are broadcast to consumers via television, radio, the Internet and print media, corporations devote many marketing dollars to the “sponsorship” of a wide variety of “events.” A sponsored event may be any athletic competition, concert, artistic performance, festival or any other occasion that is designed to attract the attendance, participation or interest of consumers of the products and services of the sponsor of the event. These events may be annual or periodic occurrence, or may be limited to a single occasion. The events are organized and administered by “property owners,” many of whom are professional entities whose sole purpose is to stage an annual event. The World Series^{SM}, the Superbowl^{SM}, the Rose Parade^{SM} and the Indianapolis 500^{SM} are all famous examples of annual events which are run by property owners, and which all enjoy the benefits of corporate sponsorship.

Despite the enormous size of this yearly expenditure, companies that seek to advertise their products by sponsoring events utilize a rather haphazard process for accomplishing their objectives. Two previous services, the IEG Network^{SM} and LitLamp.com^{SM} provide listing of some information about sponsored events. At the present time, however, no widely available, integrated database and electronic marketplace is currently operating to provide comprehensive information, and then to match buyers and sellers of sponsored events. The development of a new marketplace with customized interfaces for buyers and sellers of sponsored events would constitute a major technological advance, and would satisfy long felt needs and aspirations in the advertising and marketing industries.

### SUMMARY OF THE INVENTION

The present invention comprises methods and apparatus for creating a common platform and single point showcase for players in the event sponsorship arena. One embodiment of the present invention enables buyers and sellers of sponsored events to browse a multiple listing service of events using a website. The website may also be used to conduct searches, and save search results using a feature called the “Property Wizard^{SM}.” Although the Internet is the preferred distribution mechanism for the present invention, the invention may be disseminated to users using any public or private network, or by the distribution of discrete storage devices like compact discs.

In another embodiment of the invention, buyers may submit requests for proposals (RFPs) for events that they wish to sponsor using an “RFP Wizard^{SM}, that allows them to maintain anonymity if they choose. Sellers are able to peruse RFPs using a “Proposal Viewer^{SM}.” Both parties may obtain additional information through the website. Events may be characterized and searched using descriptive icons, dates, budgets, demographics, keywords or by other characteristics. Sellers may respond to the RFPs, and, ultimately, use the website to consummate and record transactions.

Yet another embodiment of the invention allows users to inspect discounted properties in a section called “Wise BuysSM.”

Corporate sponsors may utilize a “Corporate Management Tool,” which allows corporate users to organize and employ information about sponsored events via a geographic map with links to currently held sponsorship rights.

An appreciation of the other aims and objectives of the present invention and a more complete and comprehensive understanding of this invention may be obtained by studying the following description of a preferred embodiment, and by referring to the accompanying drawings.

### A BRIEF DESCRIPTION OF THE DRAWINGS

FIGS. 1 through 48 present “screen shots” that portray the image generated for a computer screen for one embodiment of the invention. FIGS. 49 and 50 are flowcharts exhibiting one of the methods of the invention.

FIG. 1 presents a view of a home page.

FIGS. 2, 3, 4, 5 and 6 supply views of the screens that enable the user registration process.

FIG. 7 is a “login” screen.

FIG. 8 is an example of a screen that enables a seller to find an anonymous request for proposal (RFP) from a buyer, and to provide a response.

FIGS. 9, 10, 11 and 12 depicts information about the RFP.

FIGS. 13, 14, 15, 16, 17, 18, 19 and 20 are screen shots related to the “Proposal Wizard^{SM},” and contain information about the proposals listed on the website.

FIGS. 21, 22, 23, 24, 25, 26 and 27 exhibit a series of screens, including a “Proposal Viewer^{SM},” that supply information to a buyer who provided an RFP. These screens present information concerning a reply to the buyer.

FIGS. 28, 29, 30, 31, 32, 33, 34, 35, 36, 37, 38, 39, 40, and 41 offer a sequence of displays which enable a user to perform a search, and then save the search results.

FIG. 42 portrays a screen that notifies sellers about “soon-to-expire” inventory.

FIG. 43 concerns a feature of the website which allows sellers to maximize their exposure to buyers, including a feature called “Wise Buys^{SM},” which presents discounted properties.

FIG. 44 portrays a screen which gives users the opportunity to see all categories of listed properties.

FIG. 45 is a screen shot related to the Wise Buys feature.

FIGS. 46, 47, and 48 depict a Corporate Management Tool, which allows corporate users to organize and utilize information about sponsored events.

FIGS. 49 and 50 are flowcharts that illustrate one embodiment of the RFP process.

### A DETAILED DESCRIPTION OF PREFERRED & ALTERNATIVE EMBODIMENTS

I. Overview of the Invention

The present invention offers a revolutionary new marketplace for the sponsorship industry. In one embodiment of the invention, a website available to users via the Internet provides a comprehensive source of information about events, event managers and event sponsors. Users who visit this website, Sponsorwise.com^{SM} are able to browse a database which serves as a multiple listing service for the sponsorship industry. The website also includes a search facility for retrieving specific information.

Buyers seeking events to sponsor are able to place requests for proposals (RFPs) on the website. Sellers are able to view the proposals, obtain additional information, submit a response and consummate a purchase using a variety of screens generated to facilitate the RFP process.

A corporate sponsor may organize selected data in a customized page called a “Corporate Management Tool.”

Site visitors may analyze the listing using a variety of pictographic icons, and are also invited to consider a special, discounted listings using a feature called “Wise Buys^{SM}.”

II. A Preferred Embodiment of the Invention

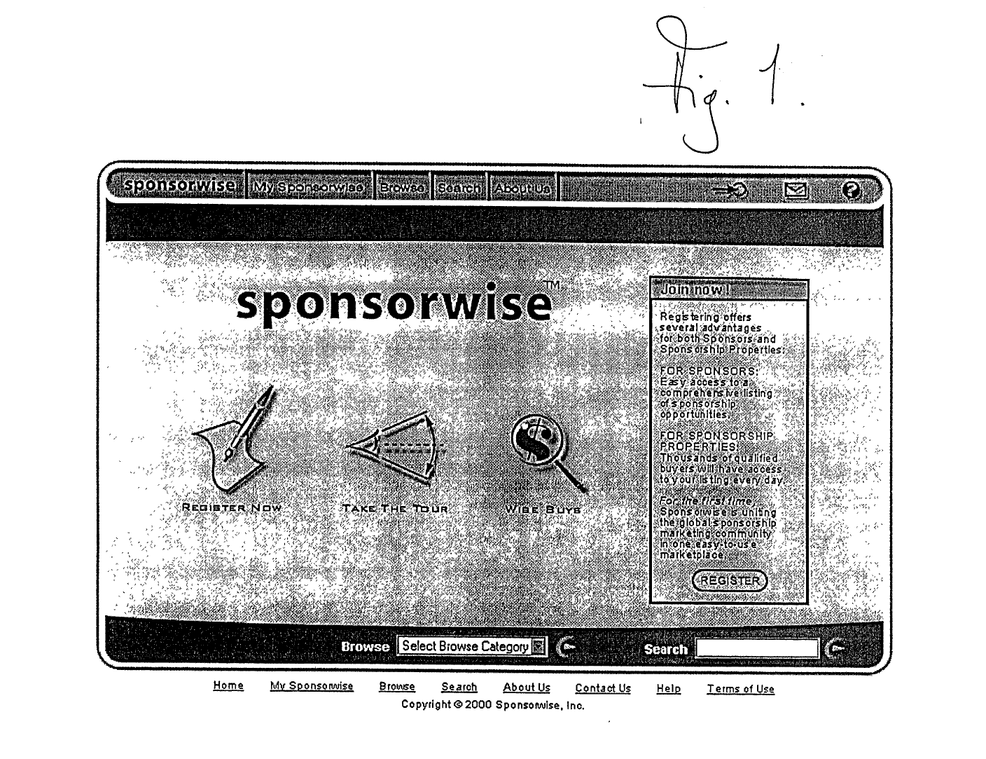

FIG. 1 is a “screen shot” of the home page of a website, Sponsorwise^{SM}.com. The screen shots that are presented in the Drawings are printed representations of the images that are displayed as various pages of one current embodiment of the Sponsorwise^{SM}.com. These screen shots are intended to disclose the present invention, but should be considered as illustrations of one of many conceivable embodiments, alternatives and equivalents.

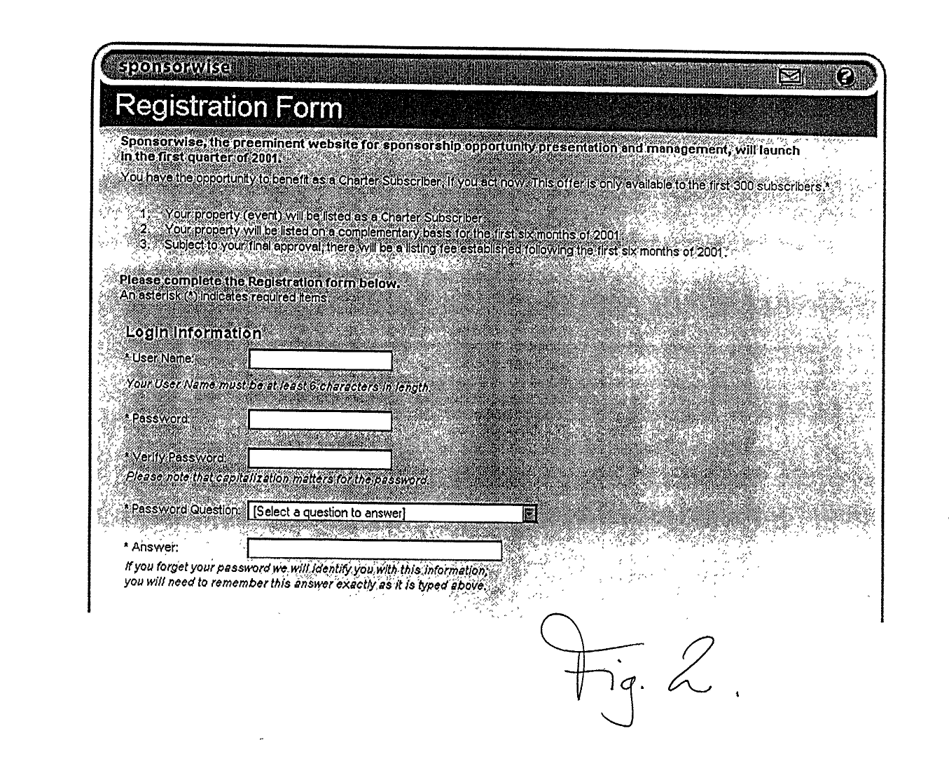

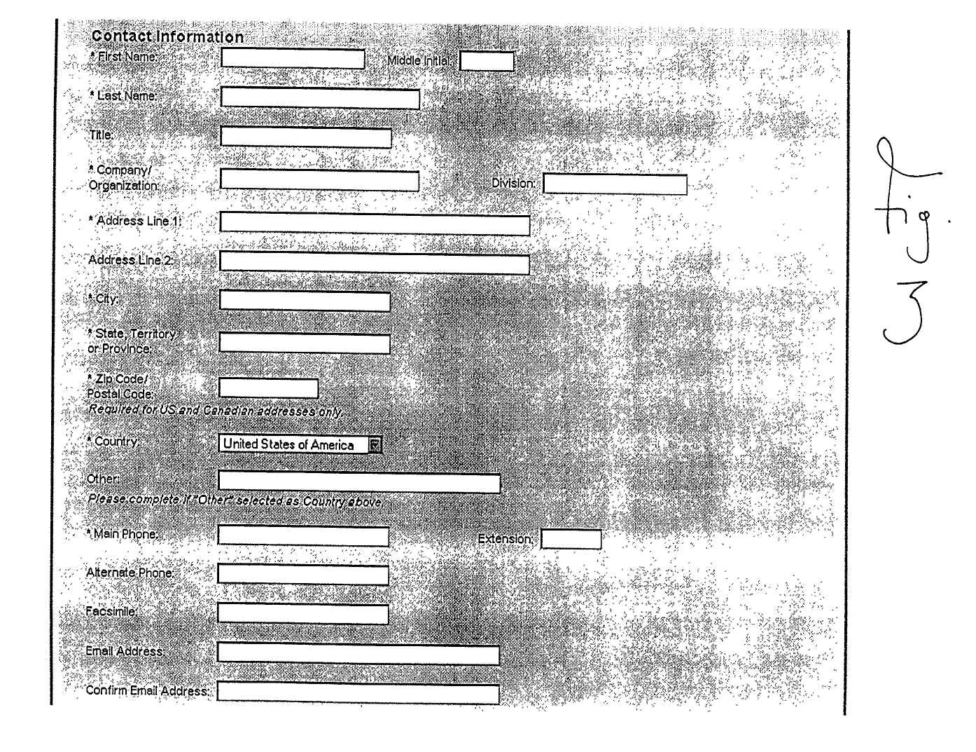

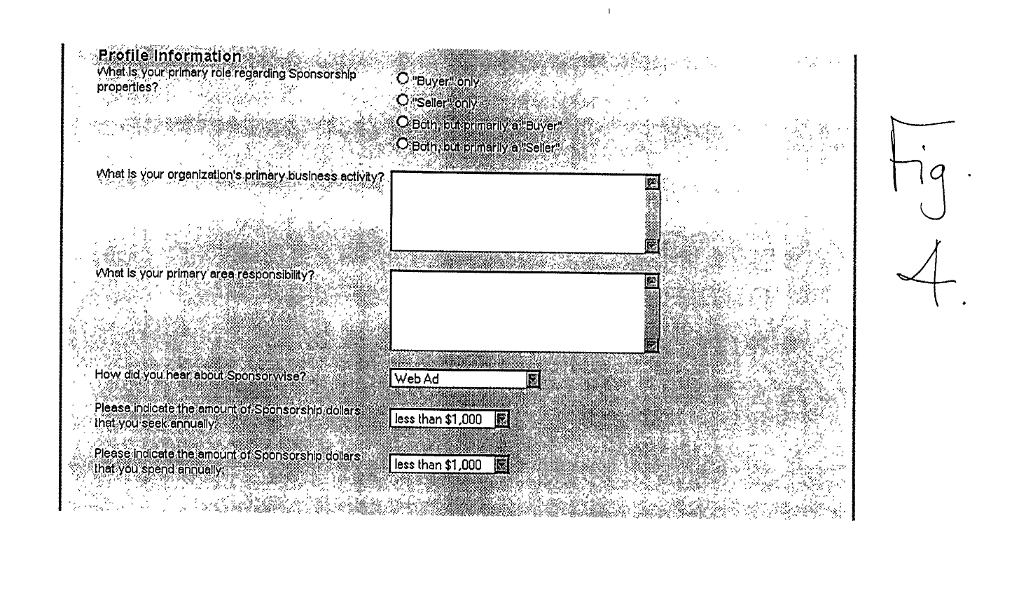

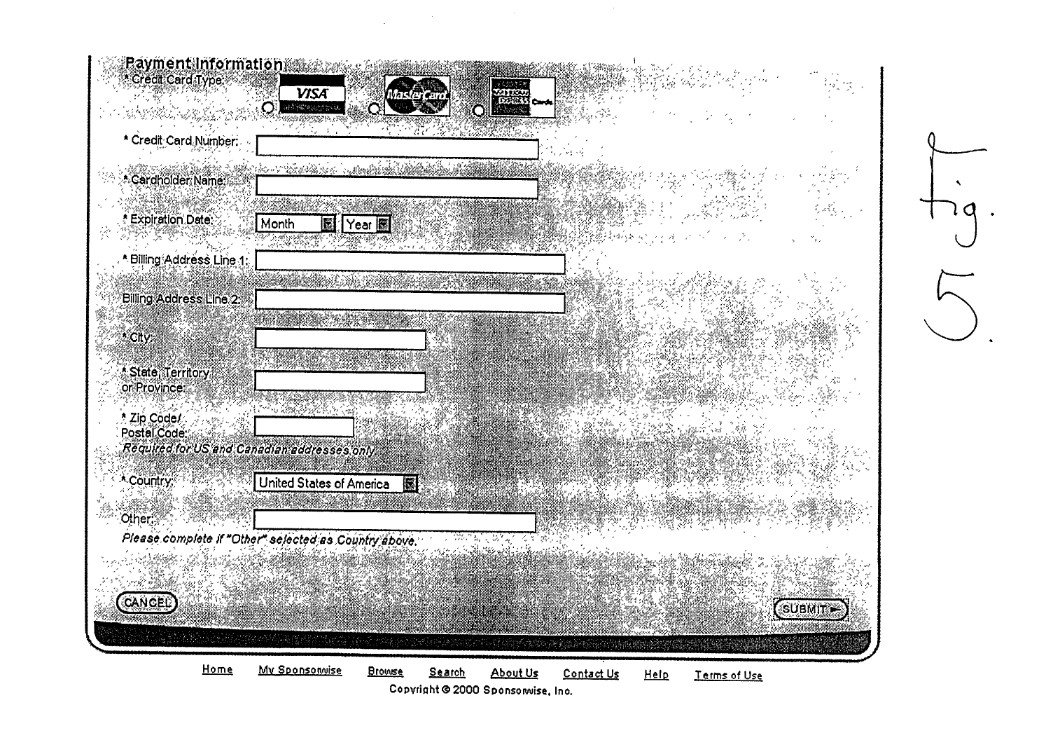

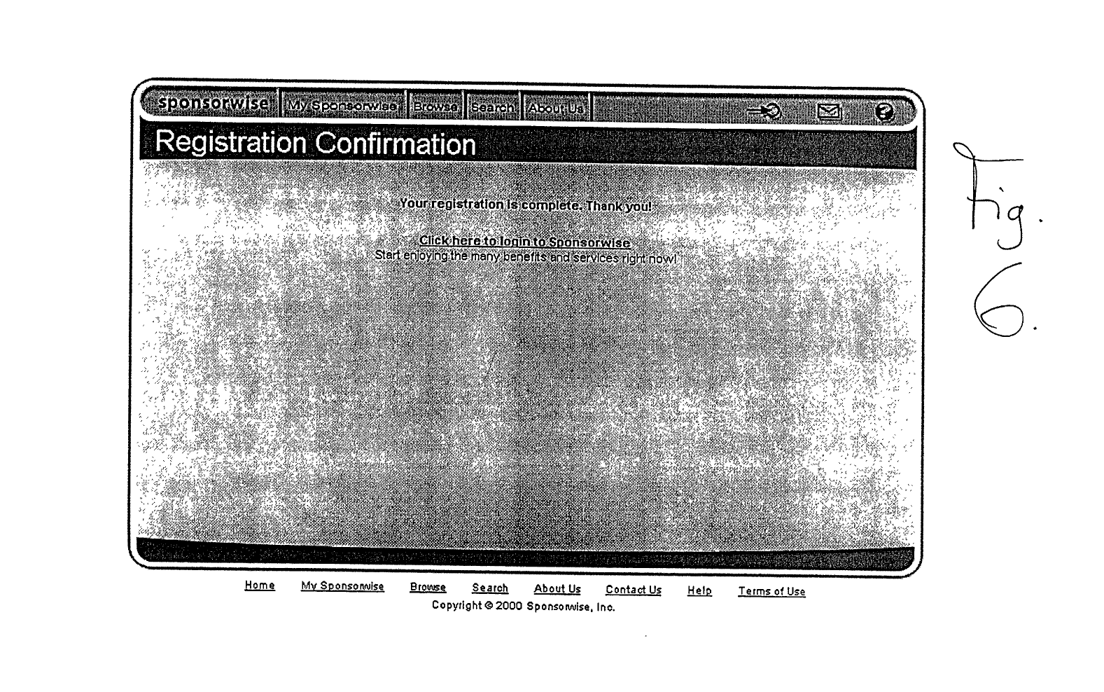

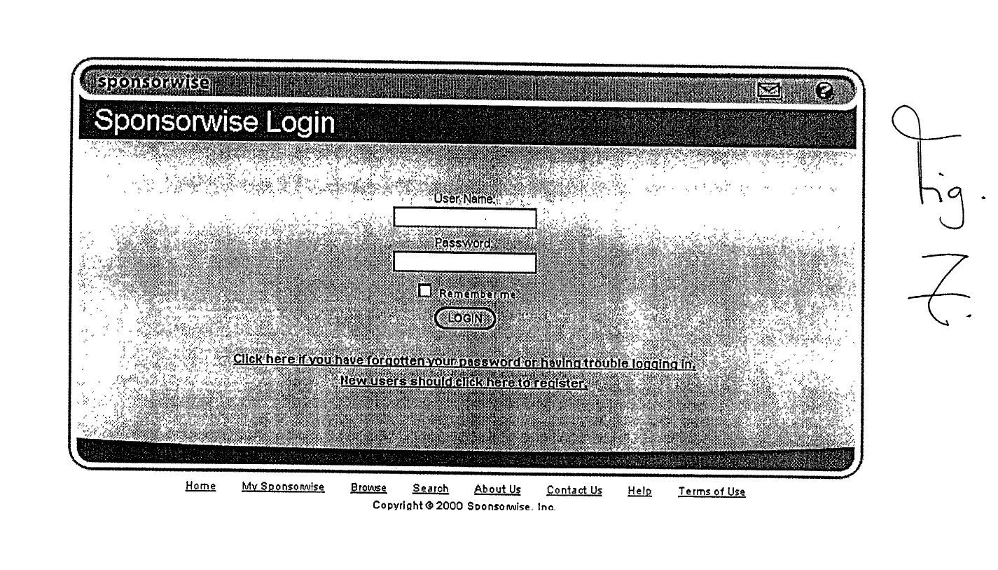

FIG. 1 shows the Sponsorwise^{SM} logo, and invites a person viewing the website to register, take a tour or inspect a property listing called “WiseBuys^{SM}. If the user wishes to register, he or she is prompted by the screens depicted in FIGS. 2 through 6 to supply a profile of information to the website. By registering, a user selects a user name and a password, and then becomes a subscriber. In one embodiment of the invention, users who become subscribers pay a subscription fee.

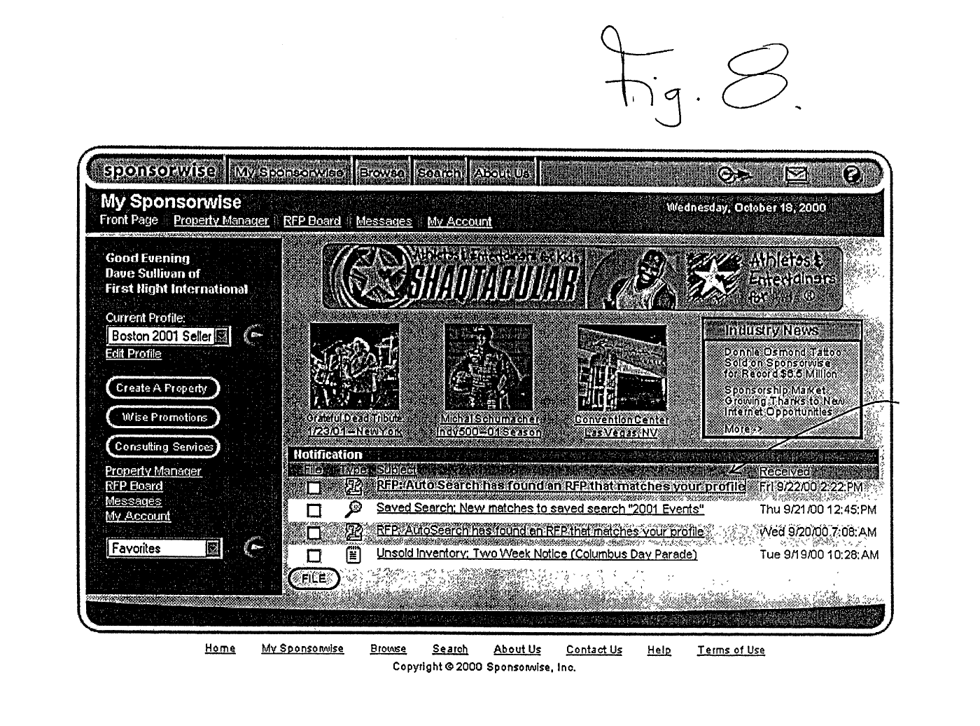

Once a user is a subscriber, he or she is allowed to enter the generally restricted pages of the website that are reserved for subscribers. Buttons displayed across the top of the screen allow a subscriber to view his or her customized pages as shown in FIG. 8, by clicking “My Sponsorwise.” Buttons for browsing and searching functions are also provided, as well as an “About Us” button which leads to page of information describing the company. The banners and photos located at the center of the screen depict events which are available for a sponsor. An “Industry News” box is also supplied to offer news items that are pertinent to the sponsorship industry. The left side of the screen enable three courses of action, and are represented by the large buttons in the darkly shaded column:

Create a Property

Wise Promotions

Consulting Services

Each of these choices takes the subscriber to a different page which contains information of interest to buyers and sellers of sponsored events.

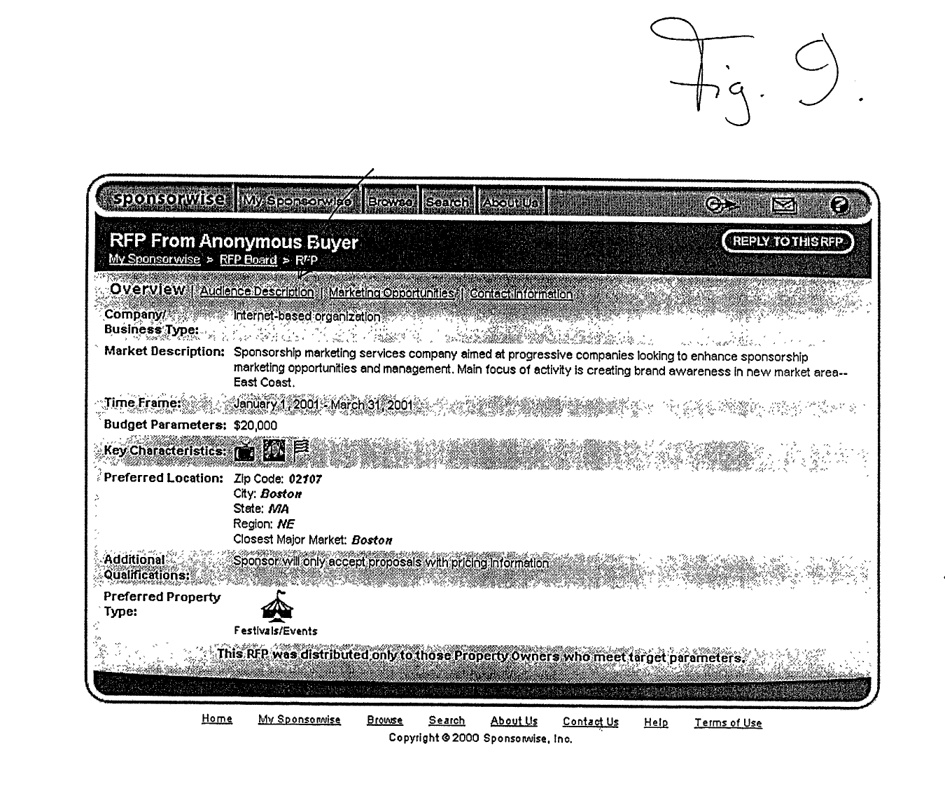

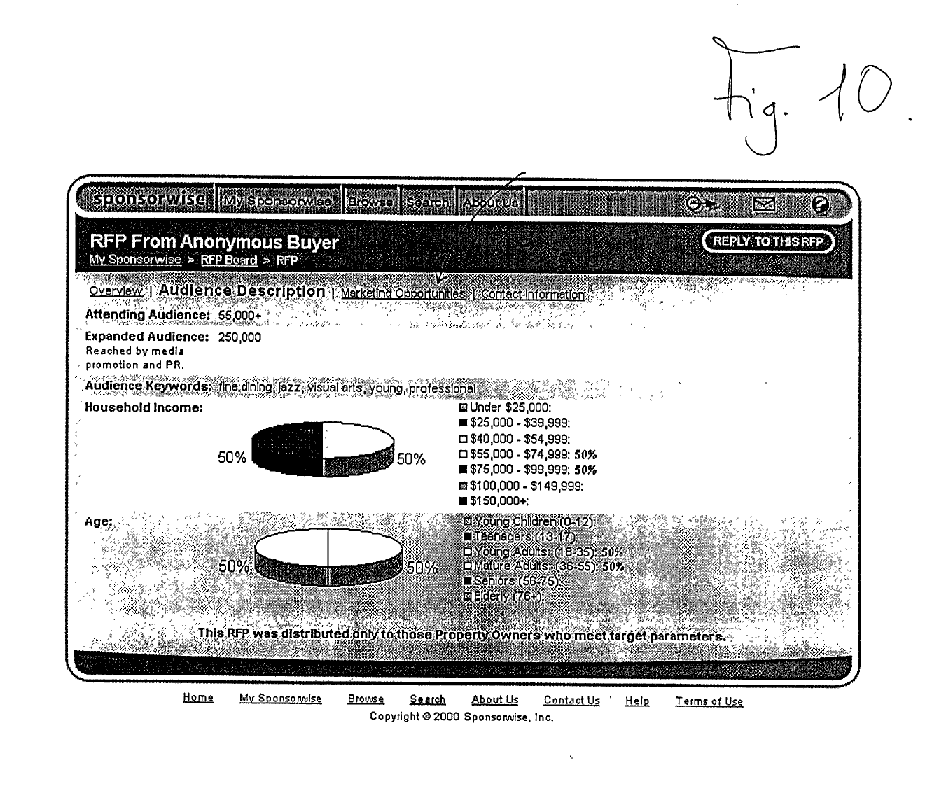

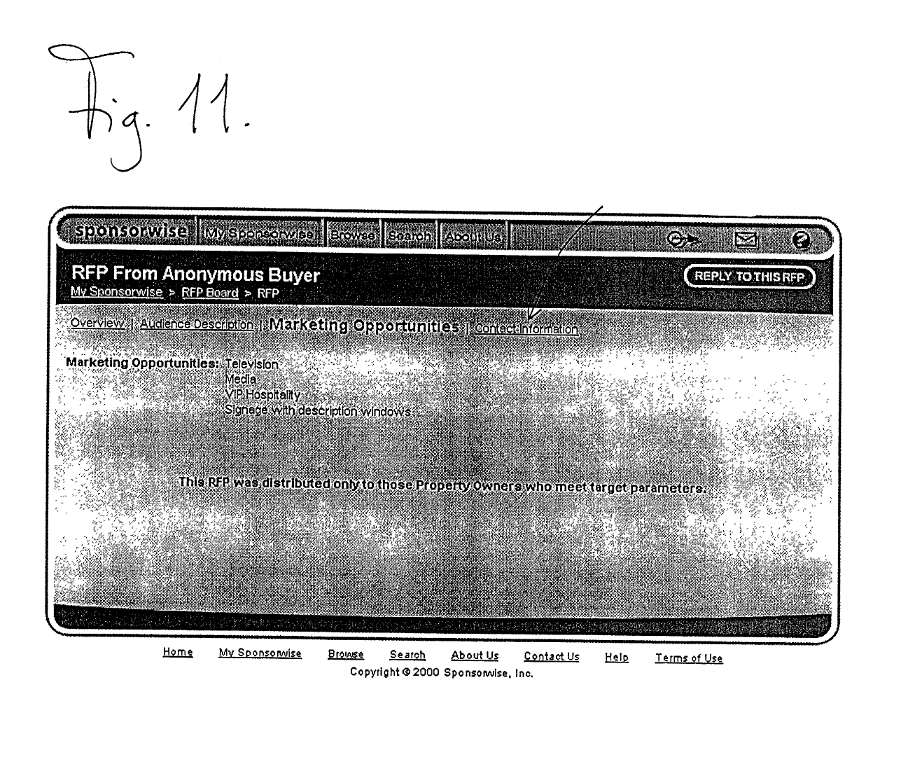

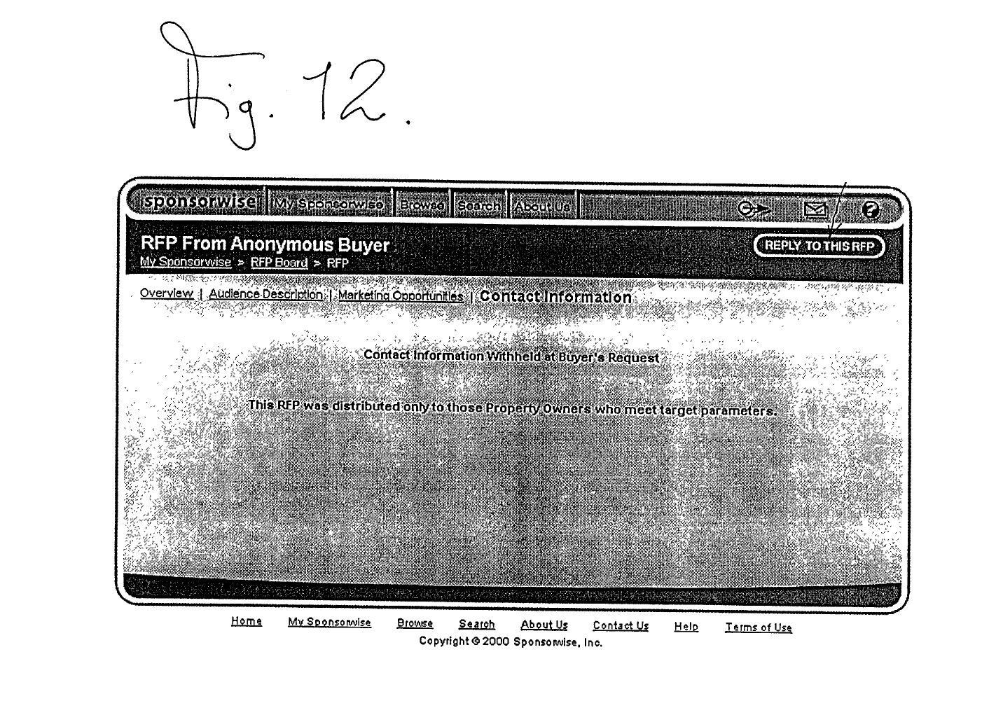

FIG. 8 reveals a page in which a seller finds, and then responds, to a proposal submitted by a buyer. The lower portion of this screen relates to the notification feature, including the RFP process, which is depicted in detail in FIGS. 9 through 12. A buyer, who may remain anonymous, may submit an RFP to Sponsorwise^{SM} by furnishing information about an sponsorship opportunity by filling in the fields in the screens generated by the website. These screens help build a description of a buyer's request, and include information about timing, the desired audience, budget, location and buyer preferences. Once this RFP information is submitted to the Sponsorwise^{SM} database, it is matched to properties. When the database finds a match between an RFP and a property, then, and only then, is the property owner notified of an RFP. The only way for the seller to reply to the RFP if the buyer is anonymous is for a seller to click the button labeled “REPLY TO THIS RFP.”

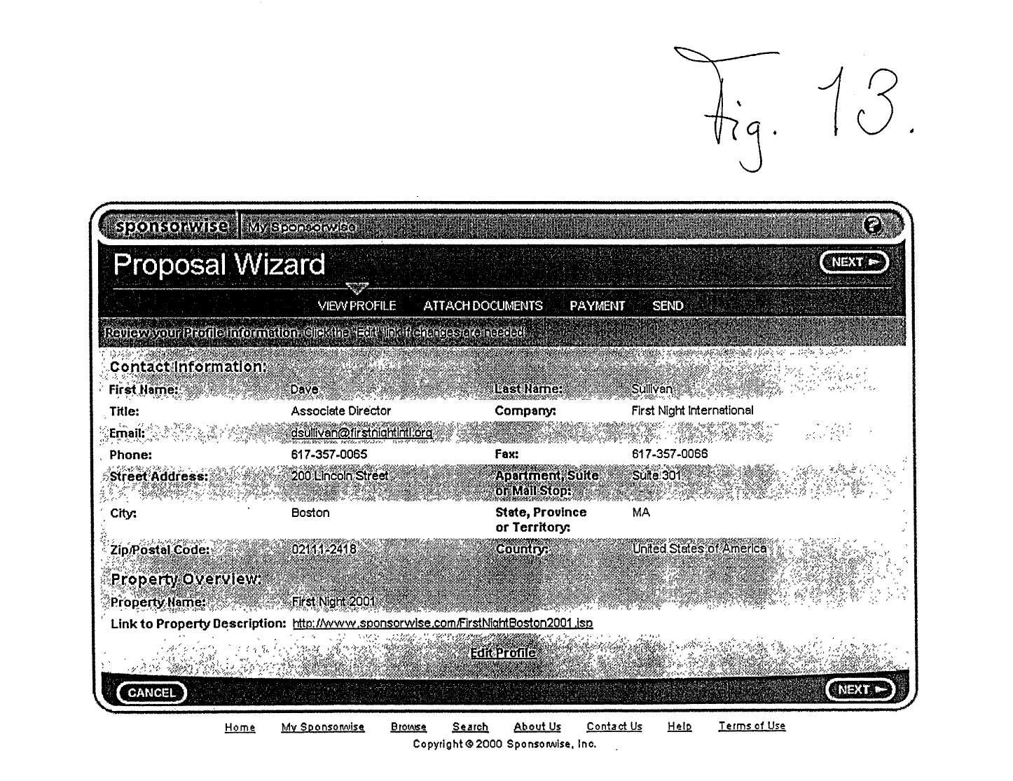

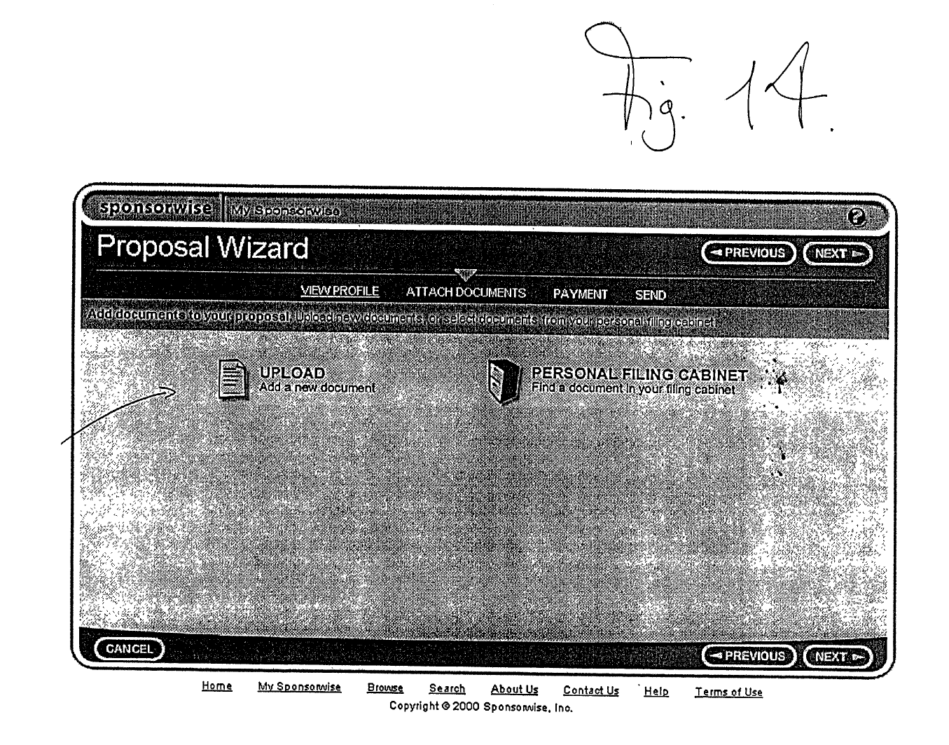

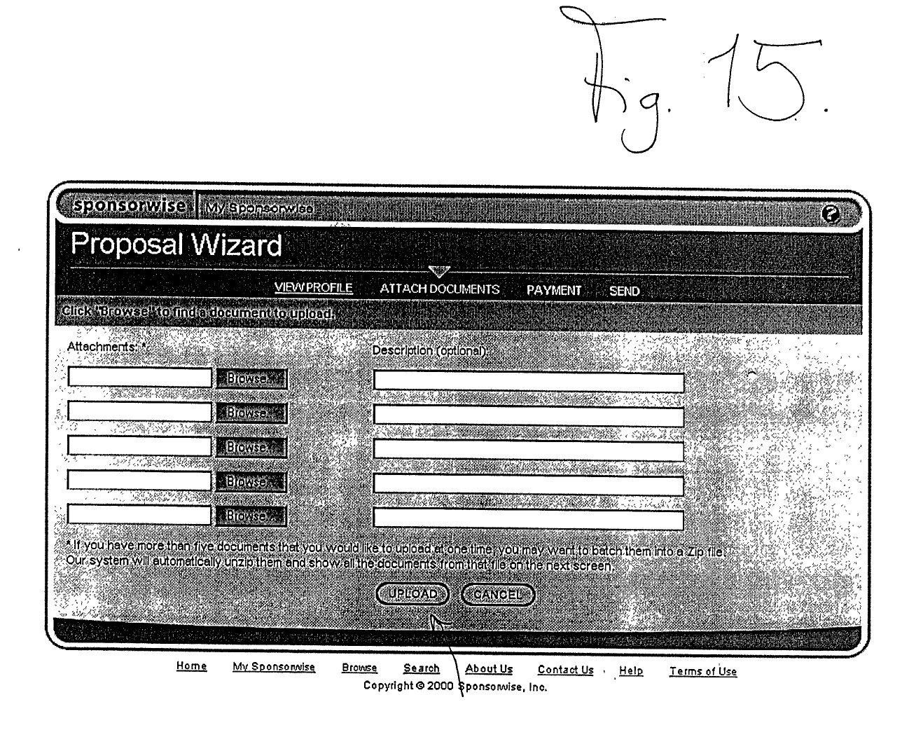

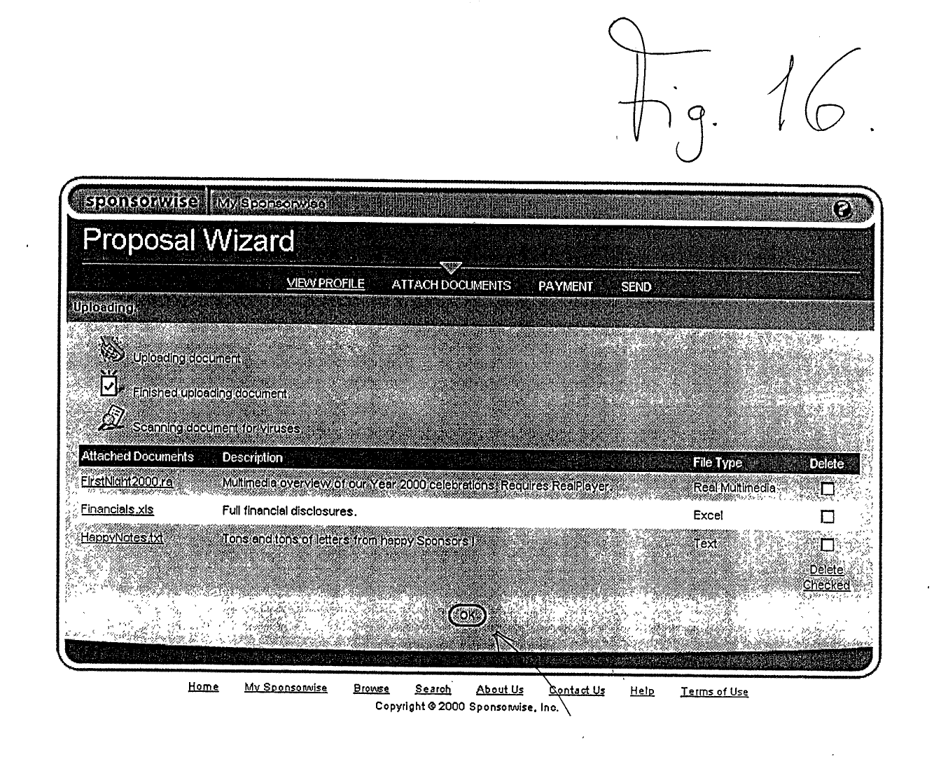

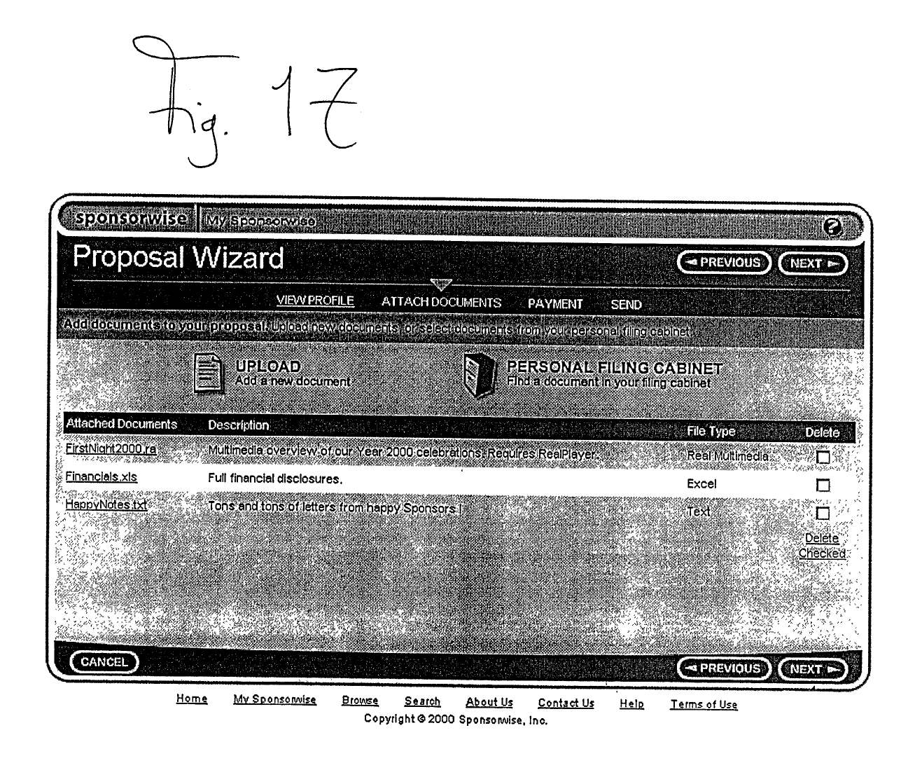

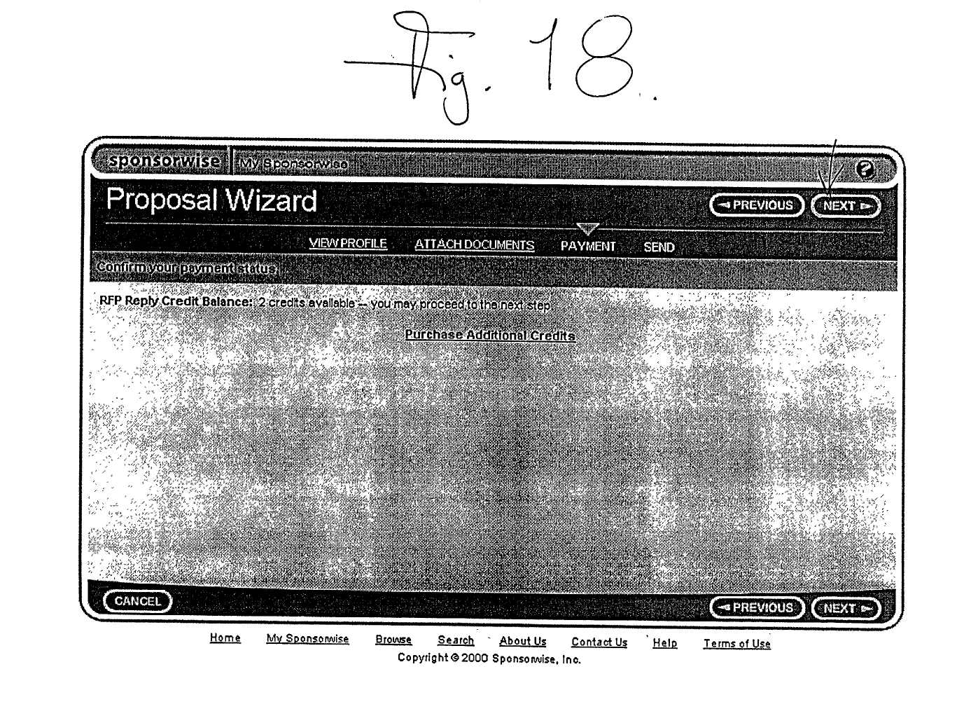

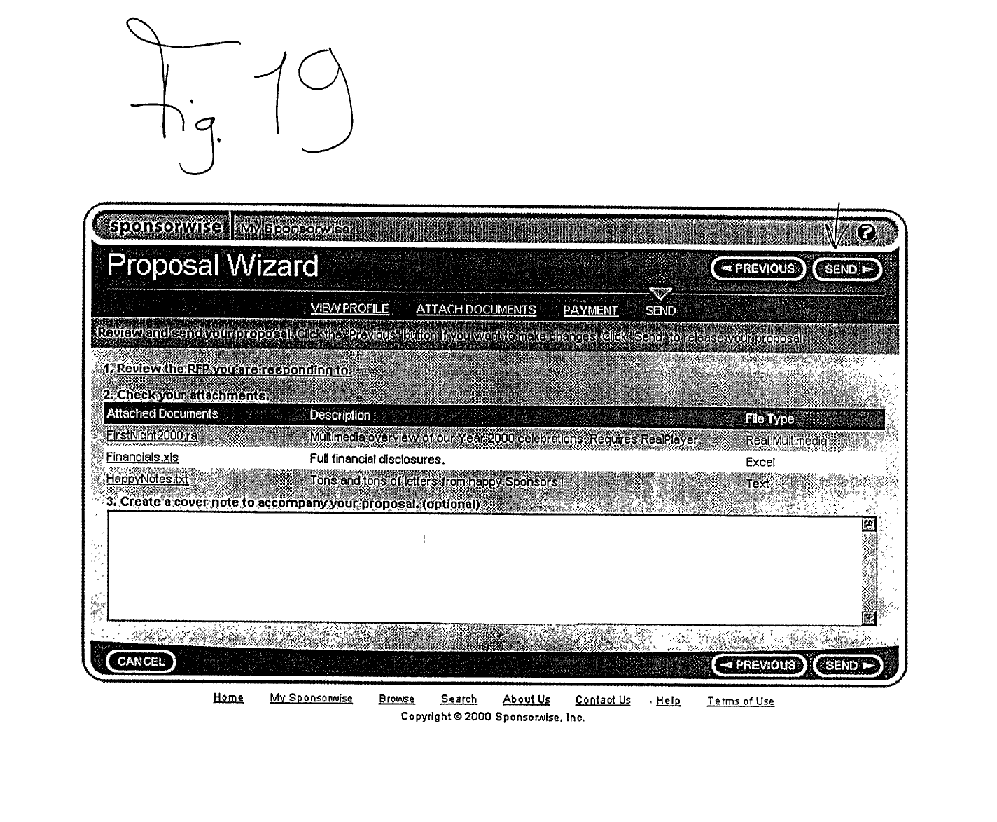

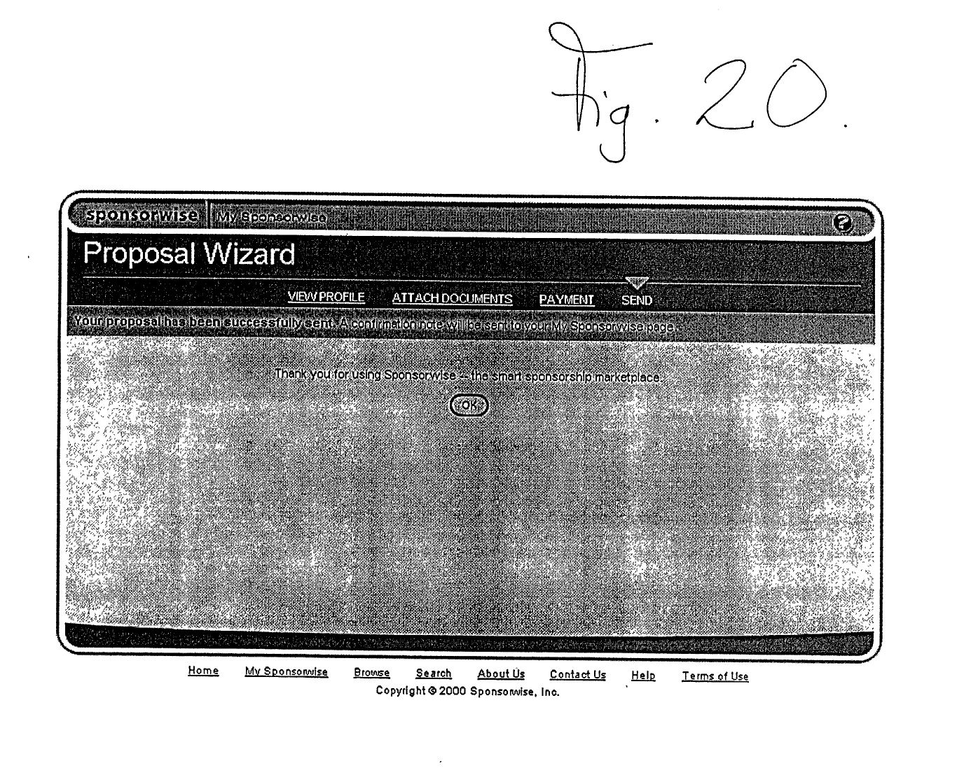

FIGS. 13 through 20 show the next step in the process, the “Proposal Wizard.” These facilities enable a buyer to build a proposal that will be submitted to Sponsorwise^{SM}, and then displayed to potential sellers (event managers). FIG. 13 exhibits a seller's contact information. As shown in FIG. 14, the Proposal Wizard allows a buyer to upload new documents, and to maintain a personal filing cabinet of information that is conveniently stored on the website. Individual documents may be added to a proposal using the fields depicted in FIGS. 15, 16 and 17. FIG. 18 reports an account balance for a subscriber, and also allows the subscriber to purchase additional SponsorwisesM credits. FIG. 19 is a screen shot which shows how an RFP is reviewed by a potential respondent.

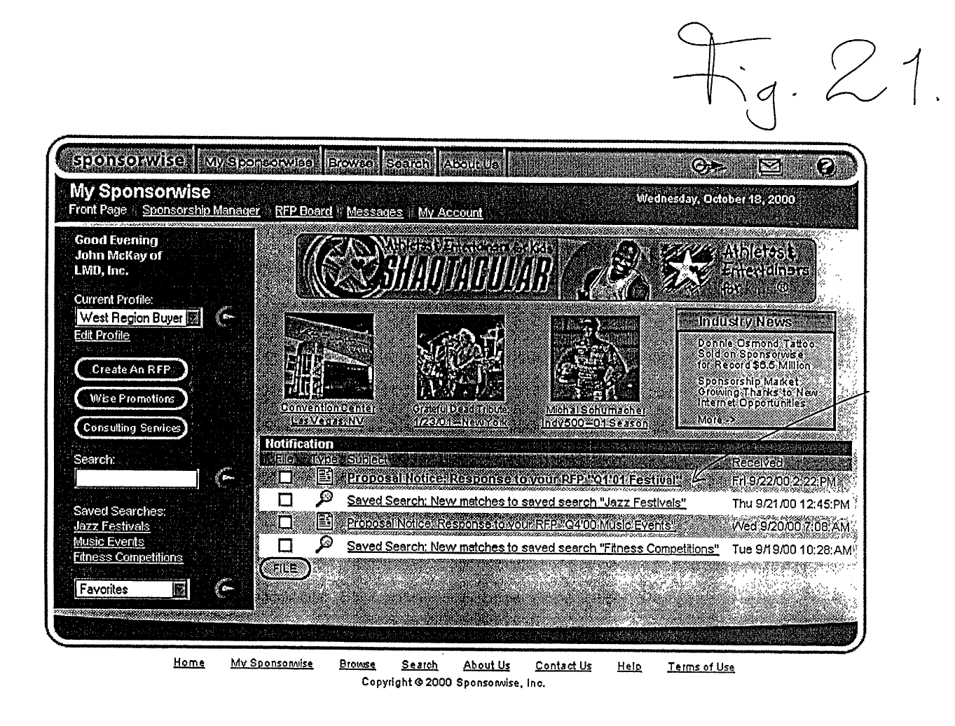

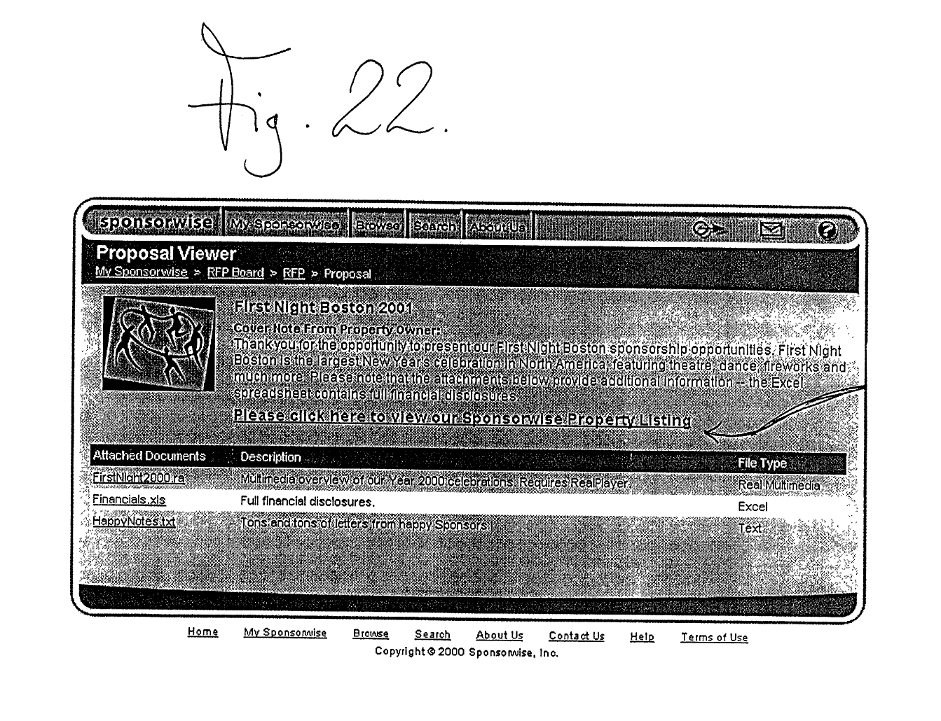

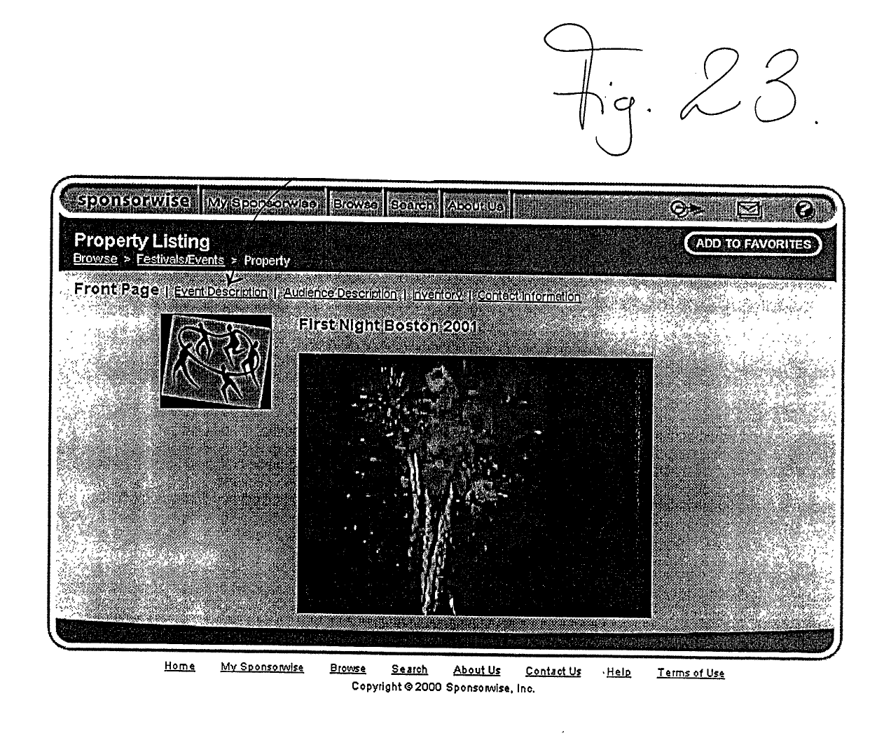

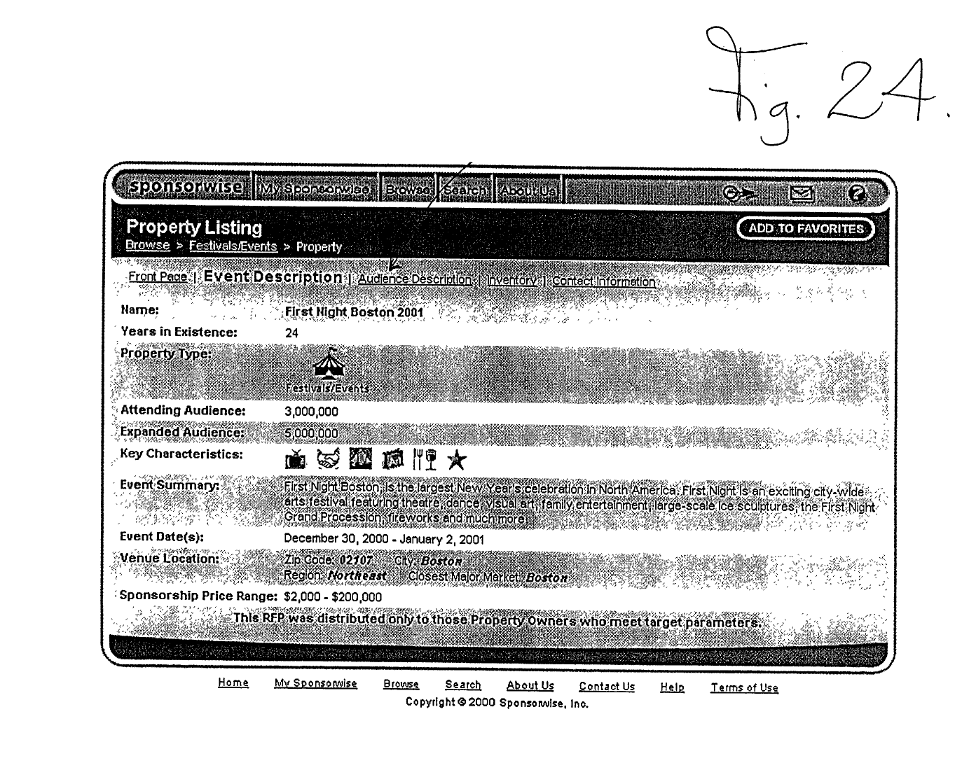

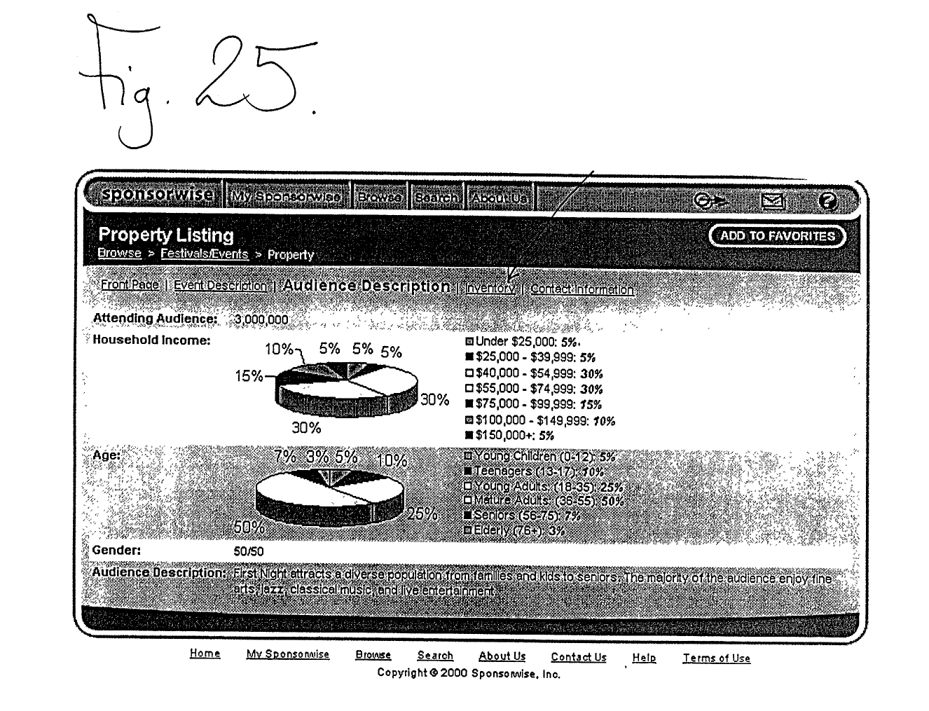

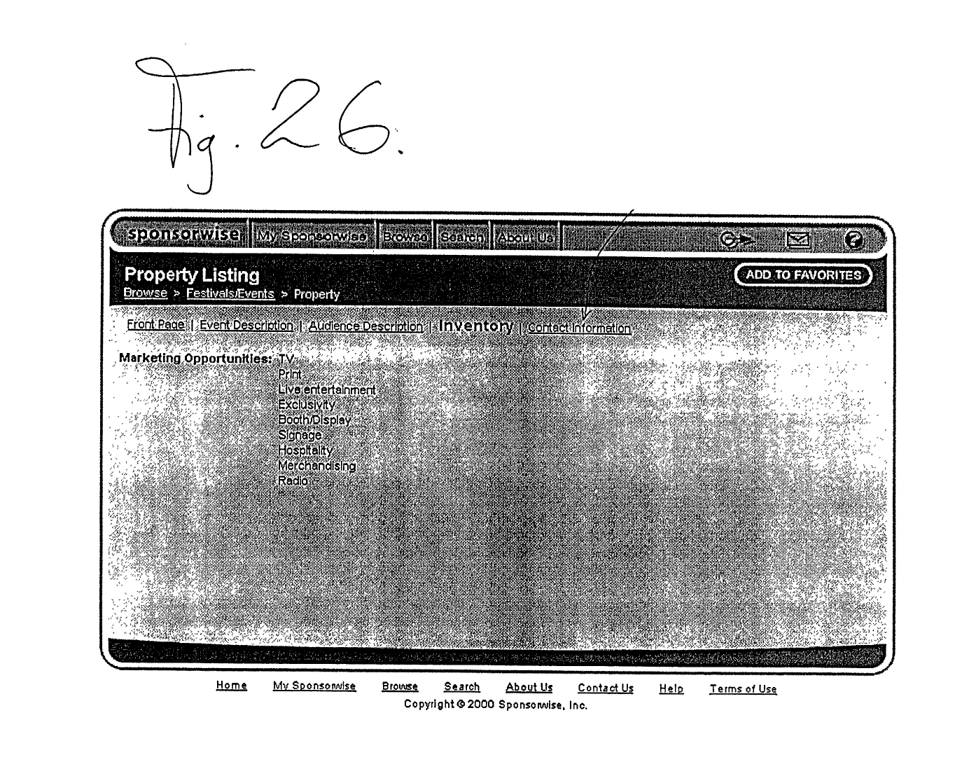

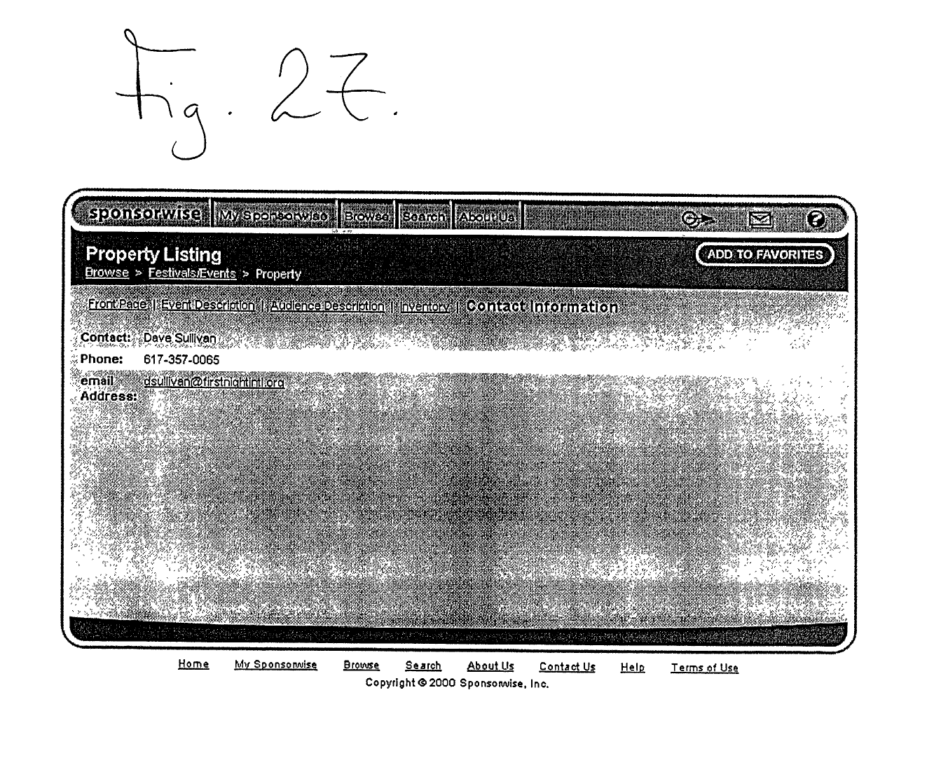

FIG. 21 reveals the details of how a buyer who previously submitted an RFP views a reply to his or her RFP. This information is furnished in the section of the screen labeled “Notification.” FIG. 22 invites the user to click to view a property listing, which is described in detail in FIGS. 23 through 27.

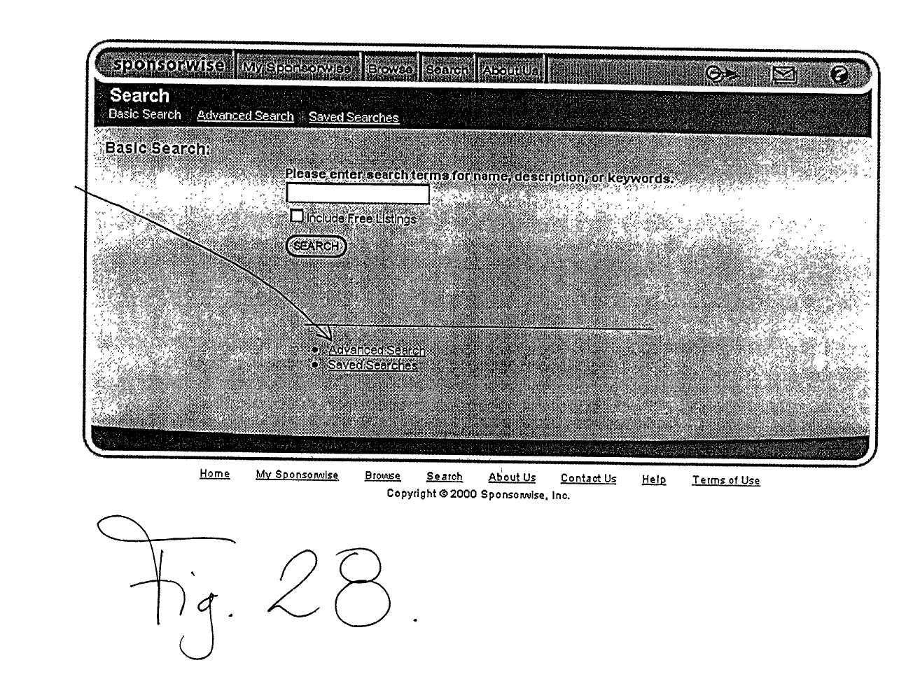

FIG. 28 is a screen shot which shows how a user employs the search function. After search results are obtained, they may be saved in the website in a page that is customized for and is only accessible to a particular user.

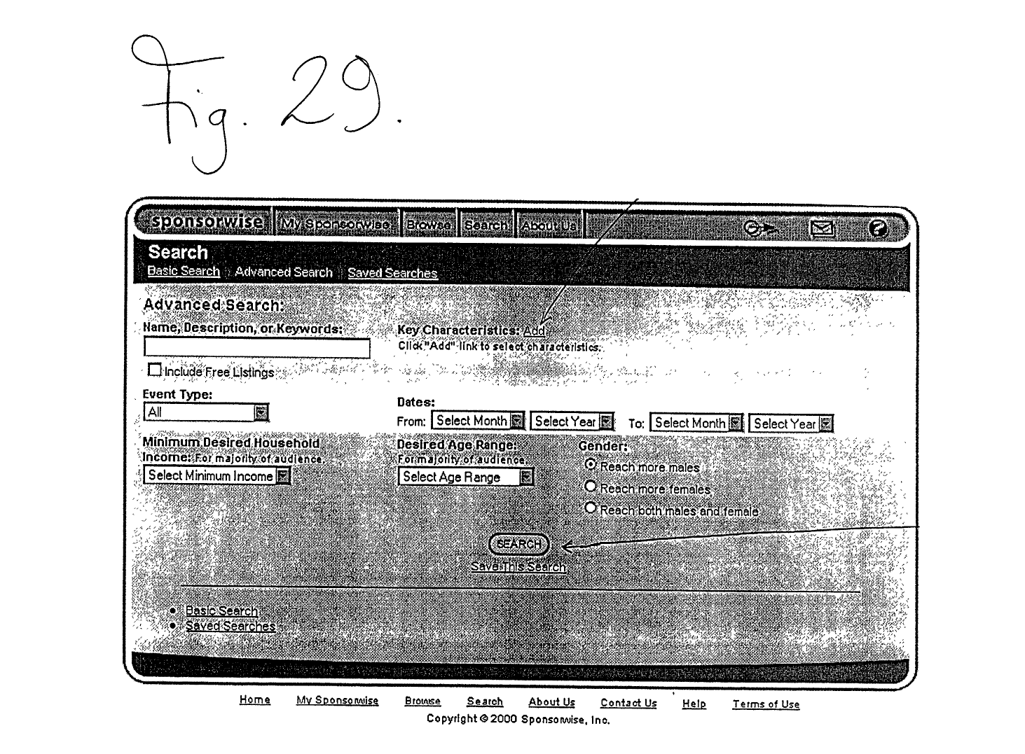

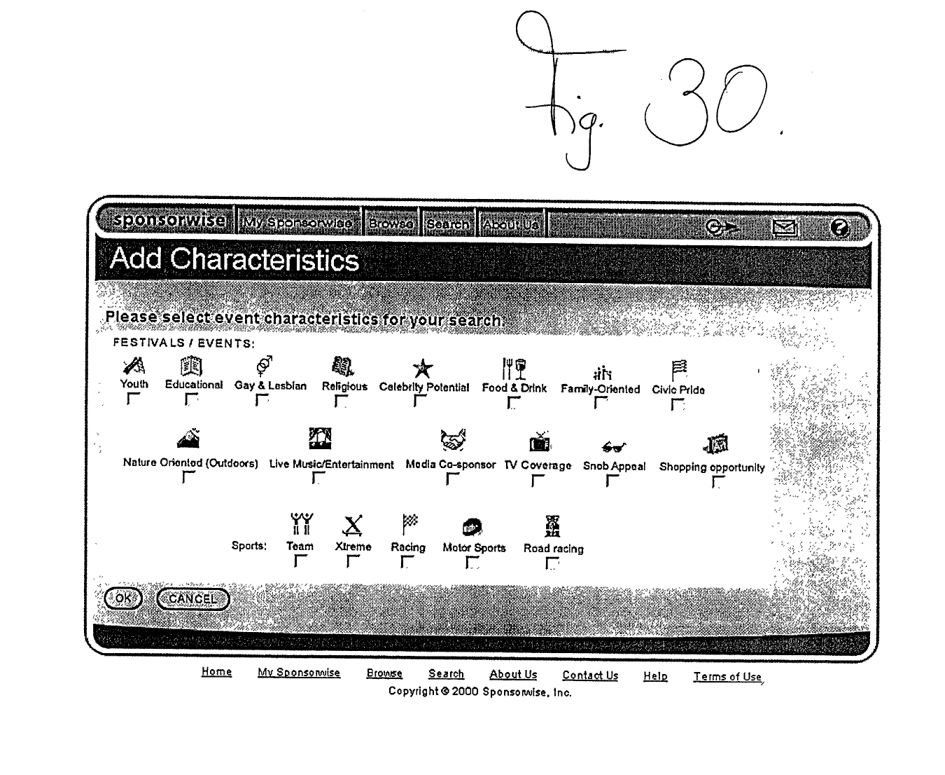

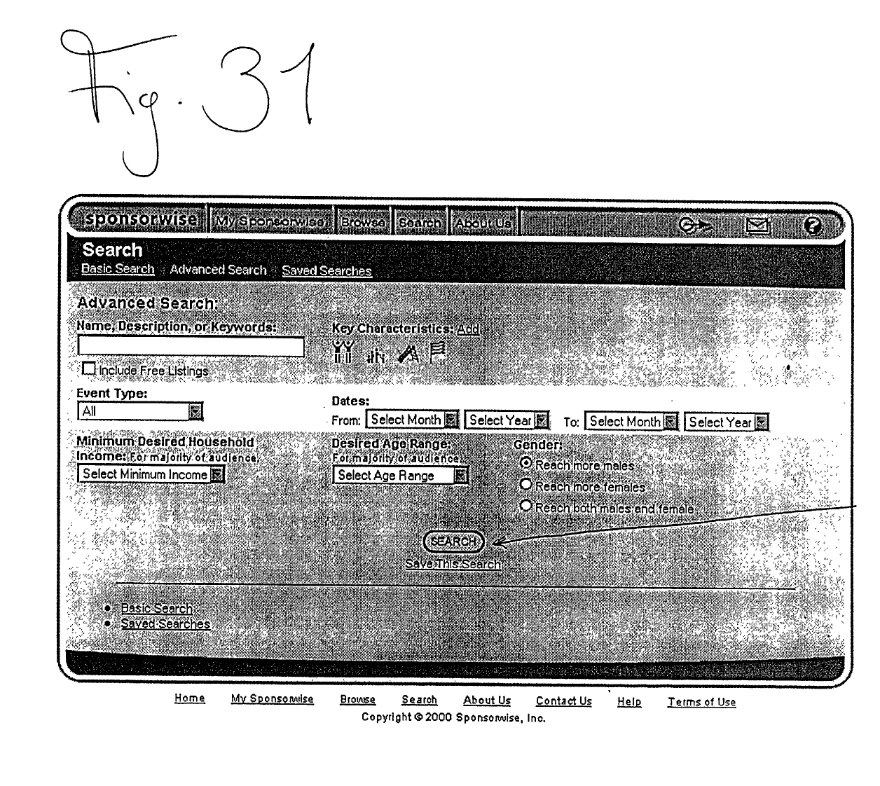

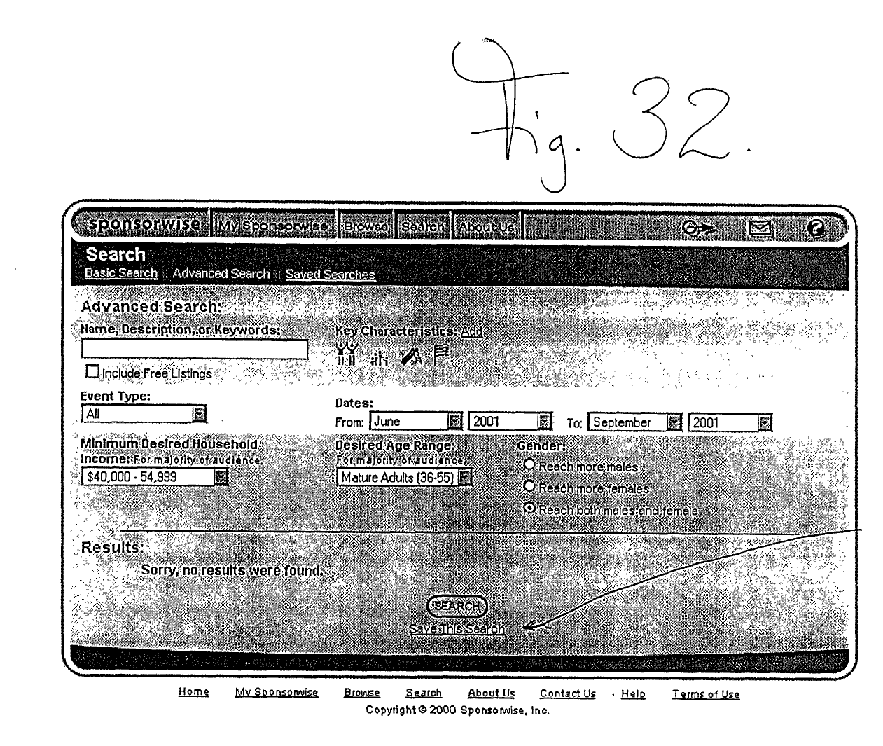

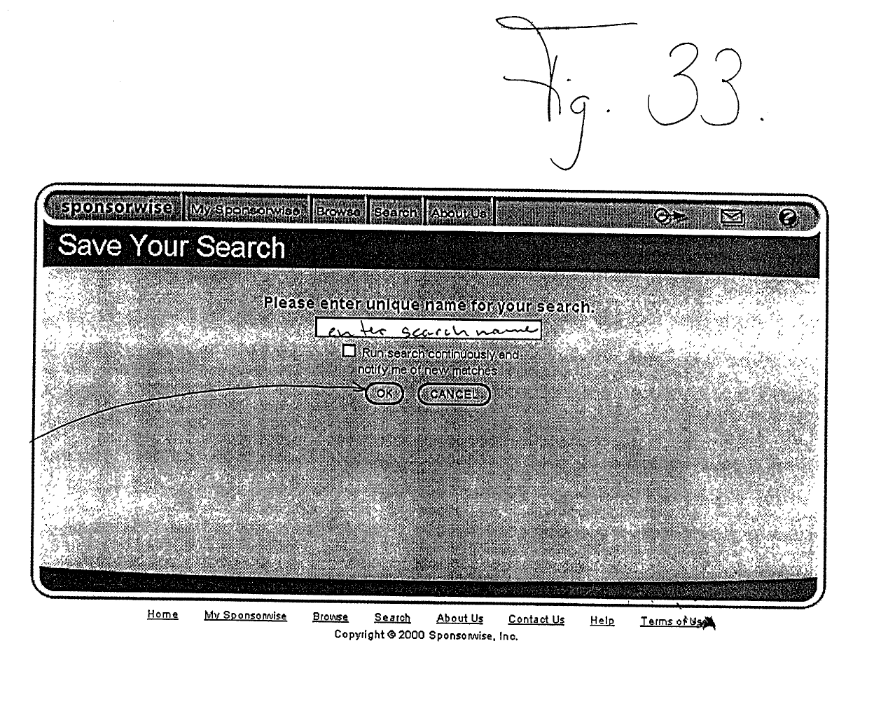

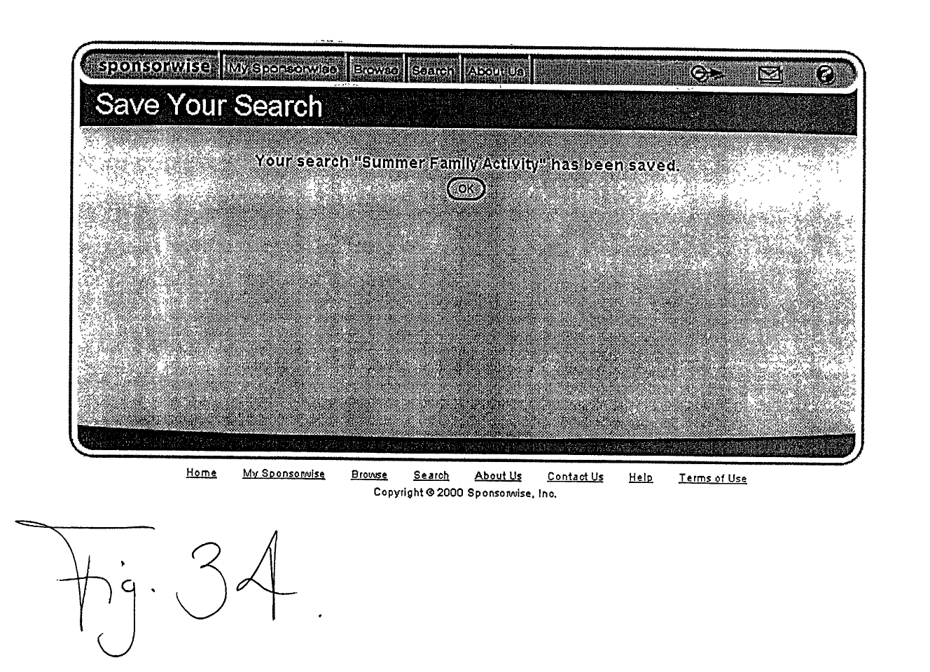

FIG. 29 pertains to “key characteristics” of property listings. FIG. 30 shows how features or attributes of an event may be displayed using icons or pictographs. For example the top row under “Festivals/Events” shows an open book, which serves as a symbol for an educational event. A star represents “celebrity potential.” A flag waving smartly from a staff connotes a patriotic event which appeals to “civic pride.” FIGS. 31 through 34 supply additional information about advanced searching, and saving search results.

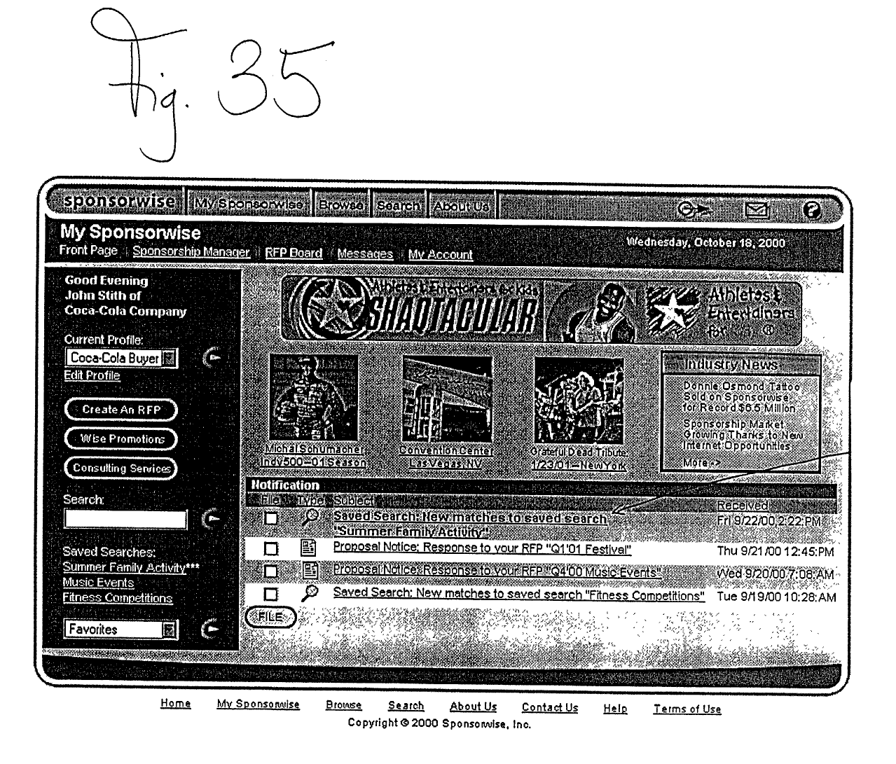

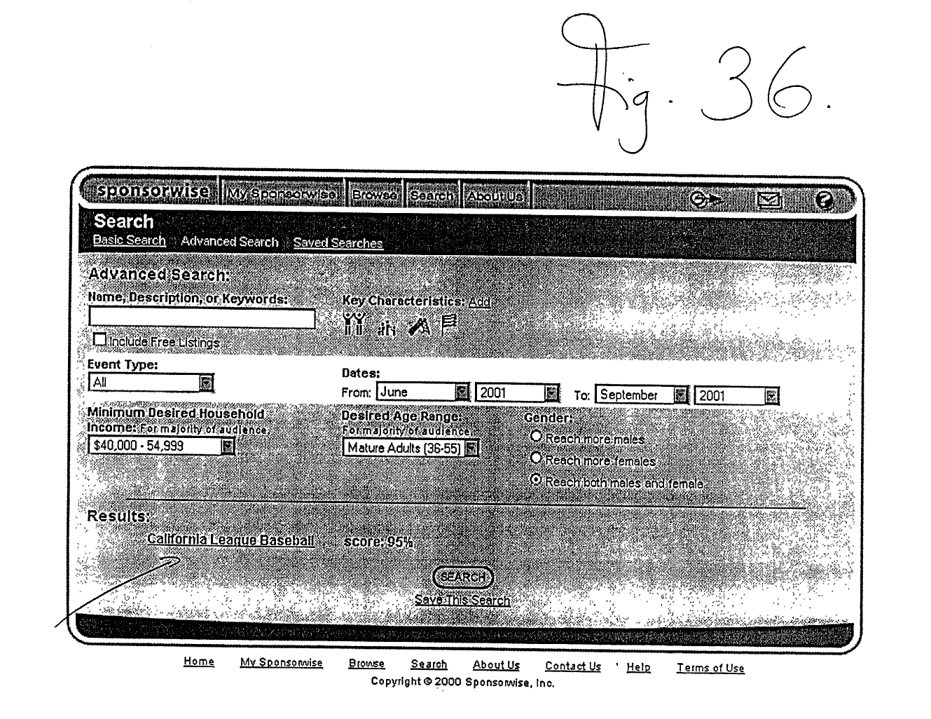

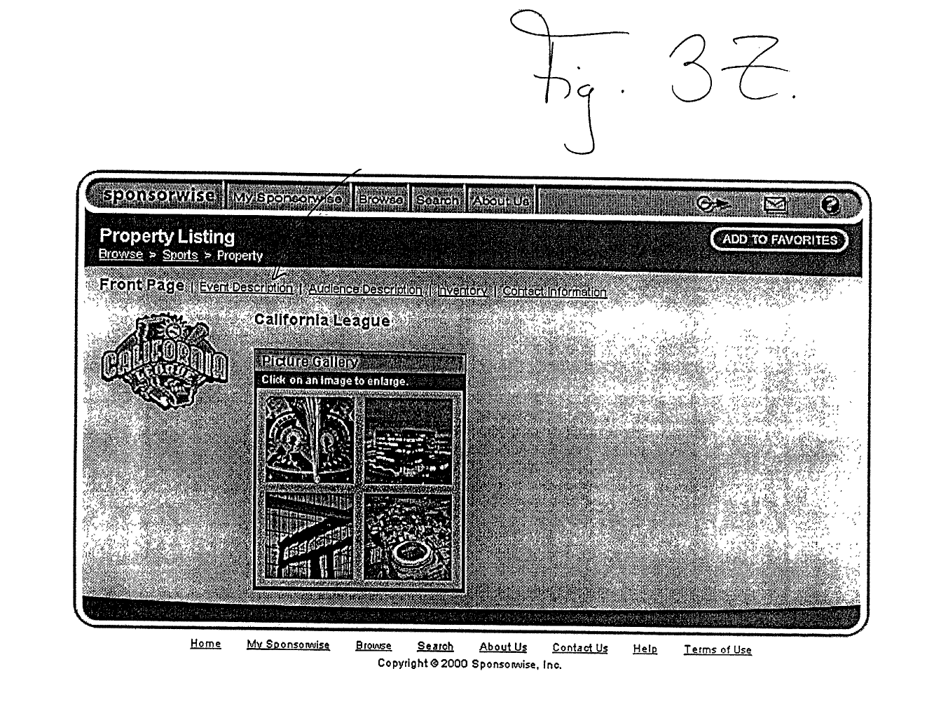

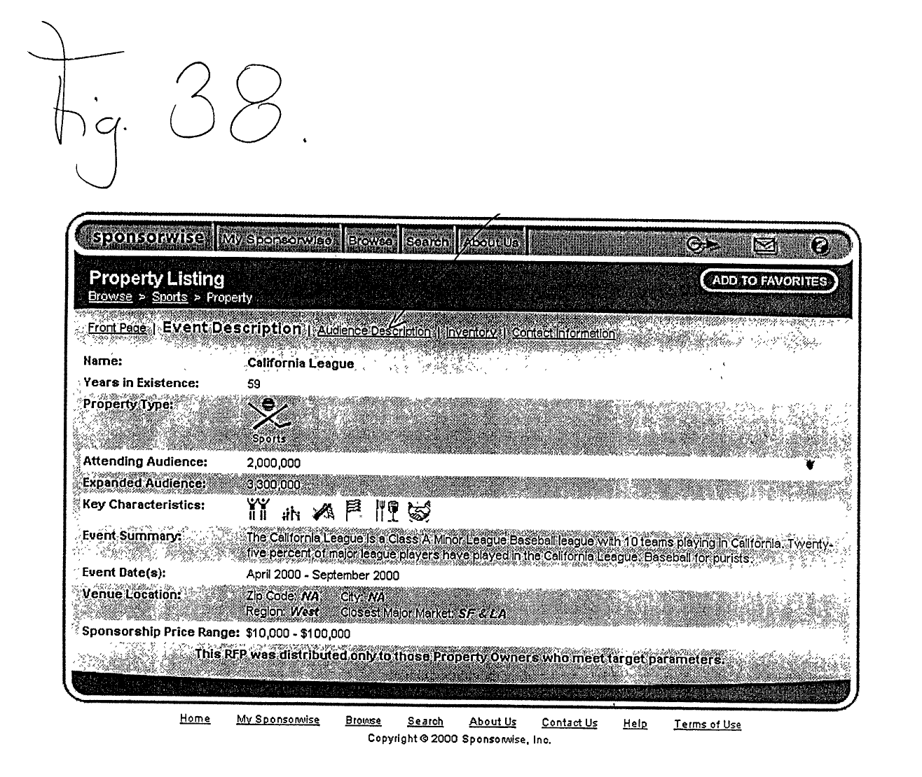

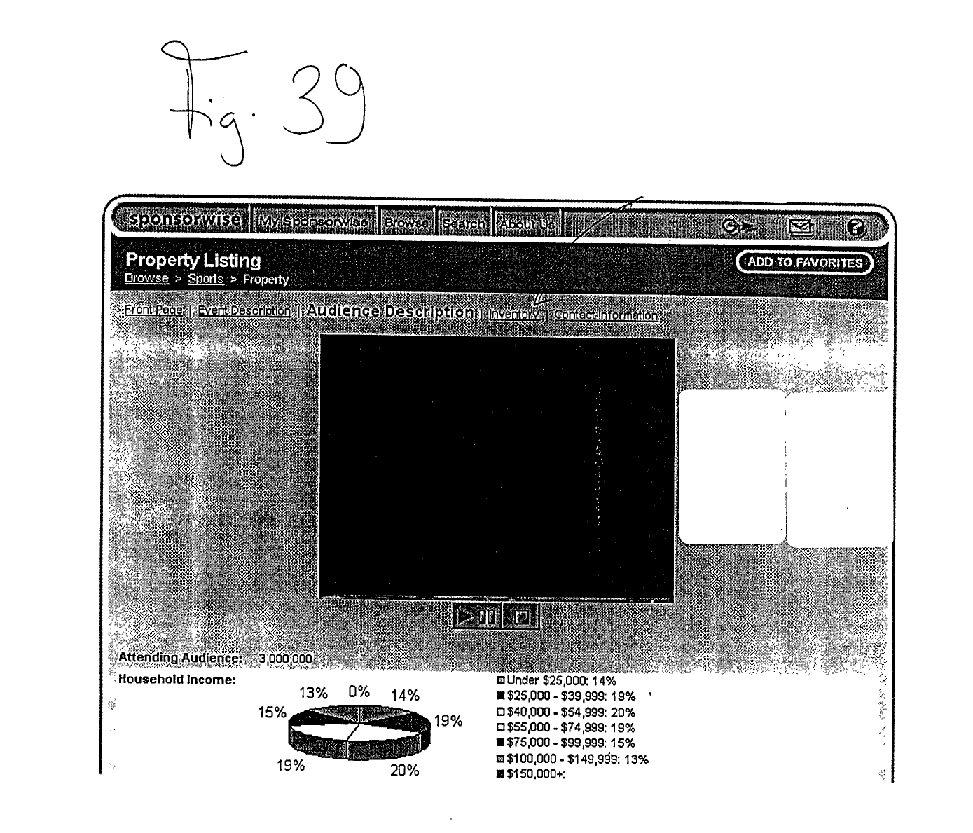

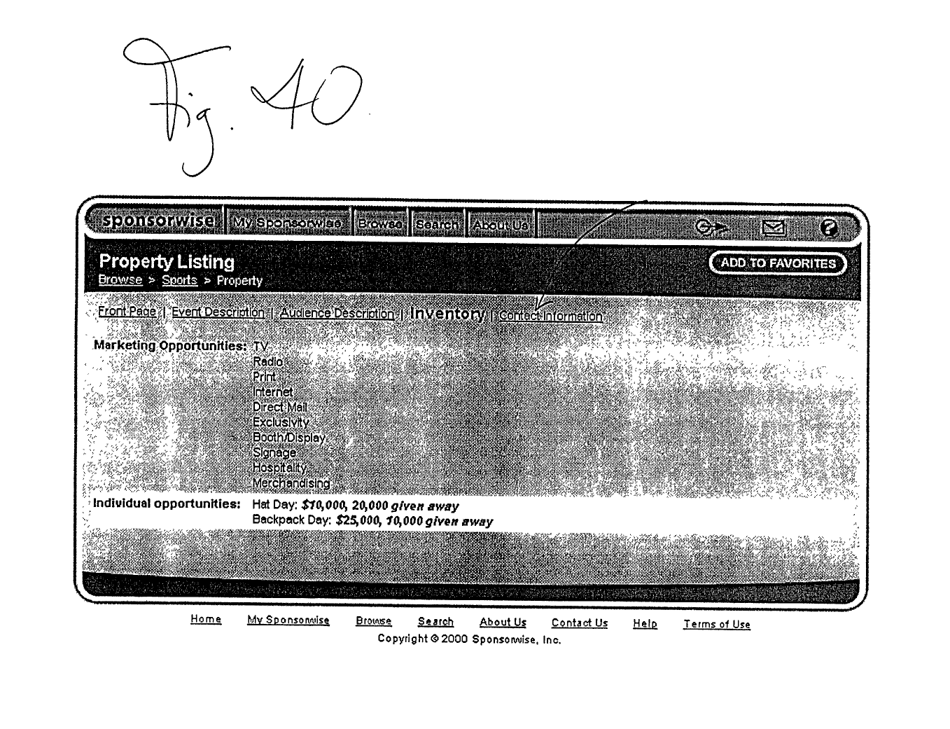

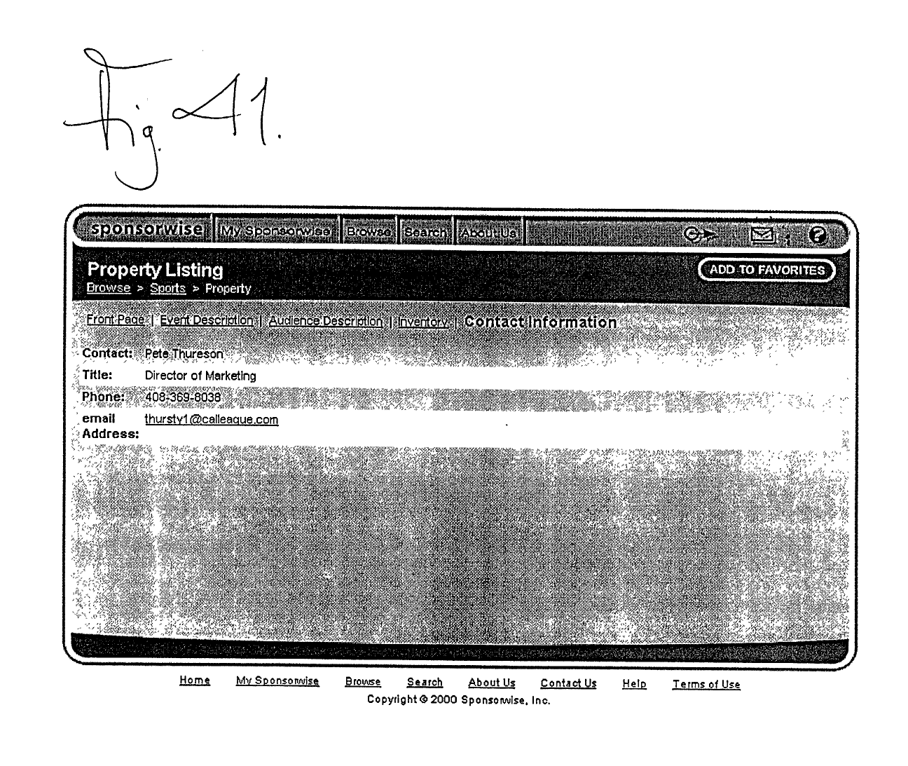

FIG. 35 is a page from the Sponsorwise^{SM} website which identifies a search identified as “Summer Family Activity.” FIGS. 36 through 41 portray a particular event, California League Baseball^{SM}, that was reported as an event which falls within the category Summer Family Activity. A wide variety of information about this event is contained in FIGS. 36 through 41, including a small screen which enables viewers to watch a video about California League Baseball^{SM}.

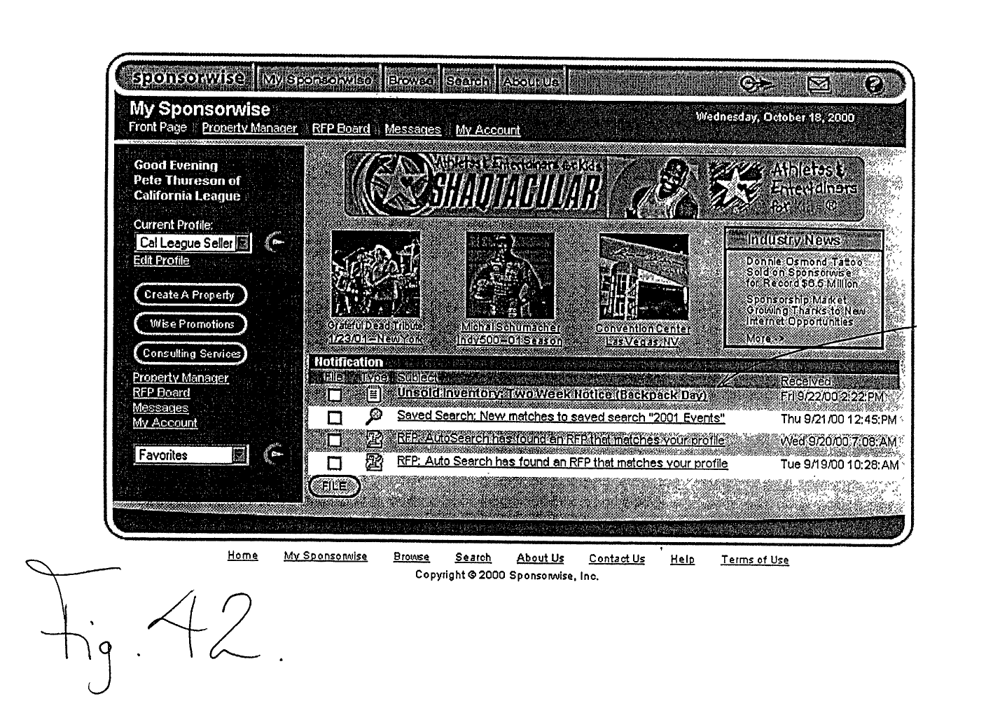

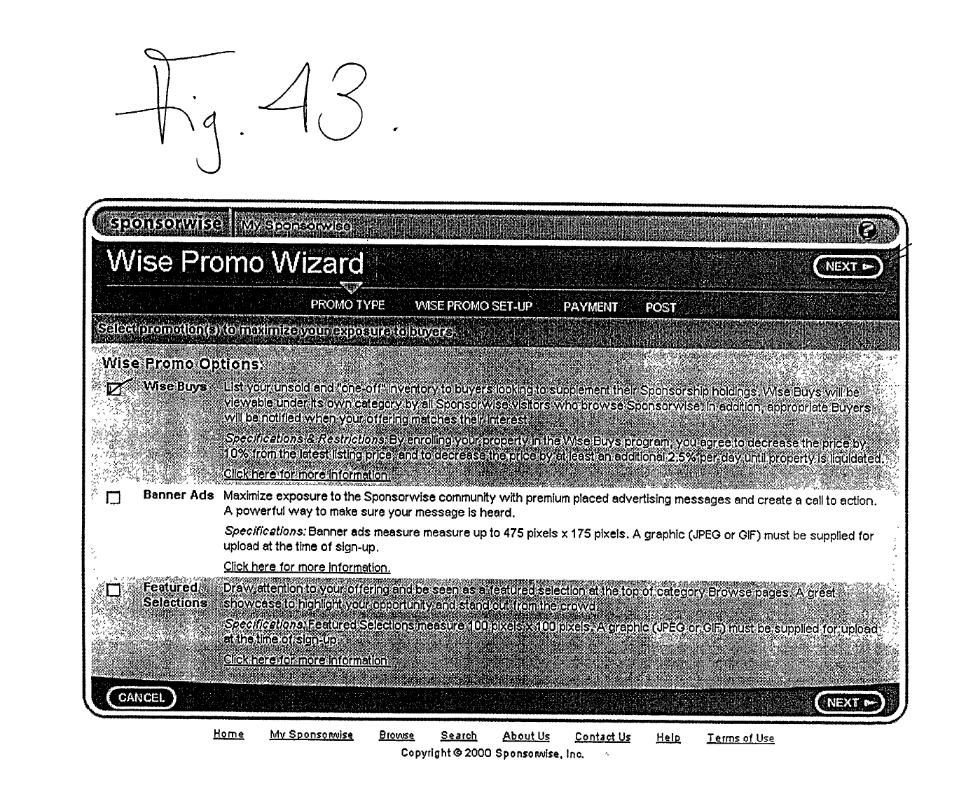

FIG. 42 describes another feature of the invention, which pertains to “soon-to-expire” inventory. The “Wise Promo Wizard^{SM},” is pictured in FIG. 43. This feature includes a listing of discounted events which is called “Wise BuysSM.”

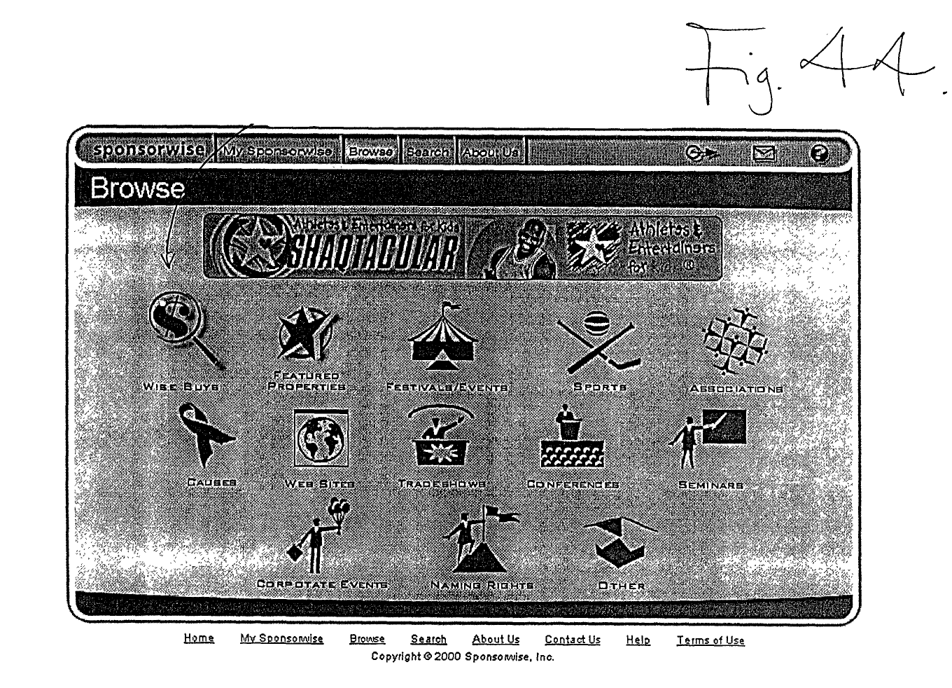

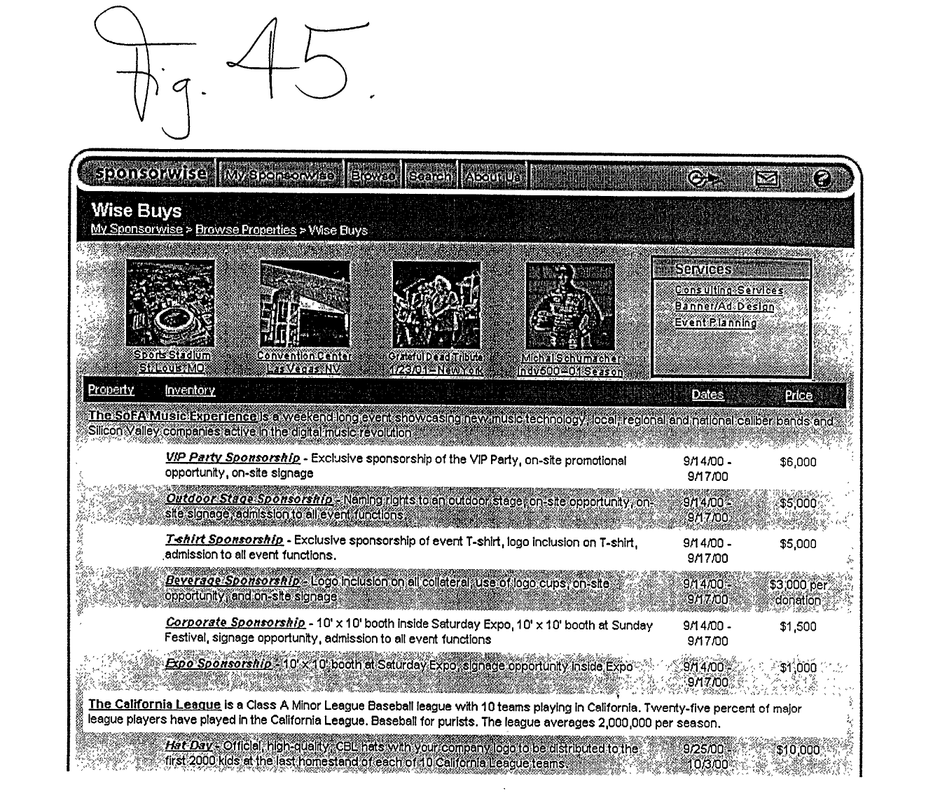

FIGS. 44 and 45 illustrate a screen which allows users to view all categories of the Sponsorwise^{SM} database, including unsold inventories.

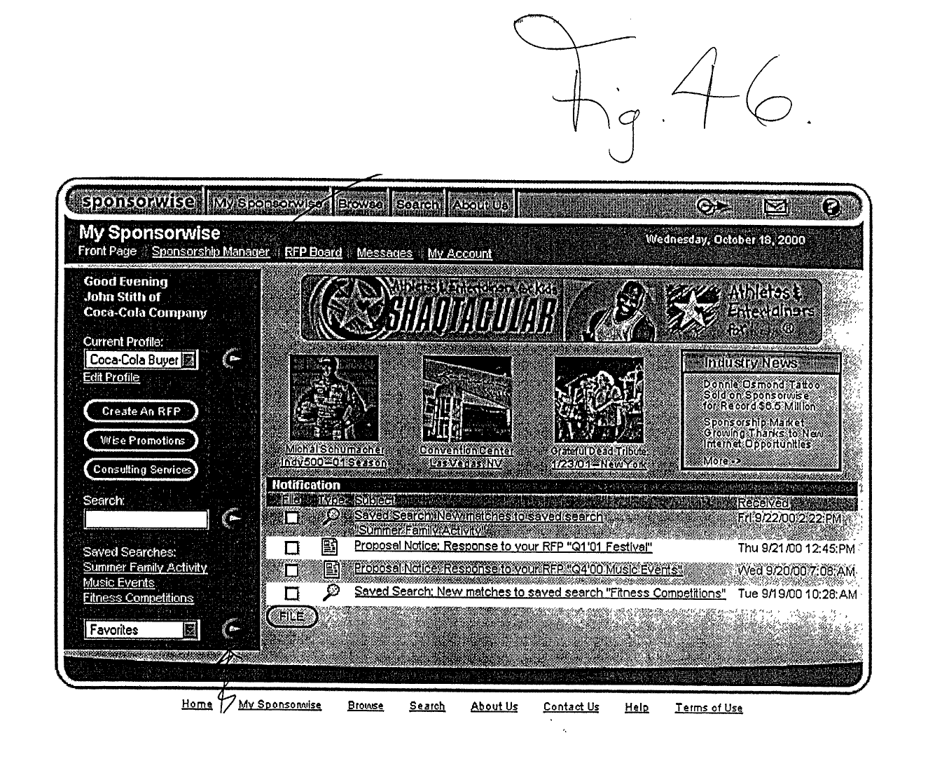

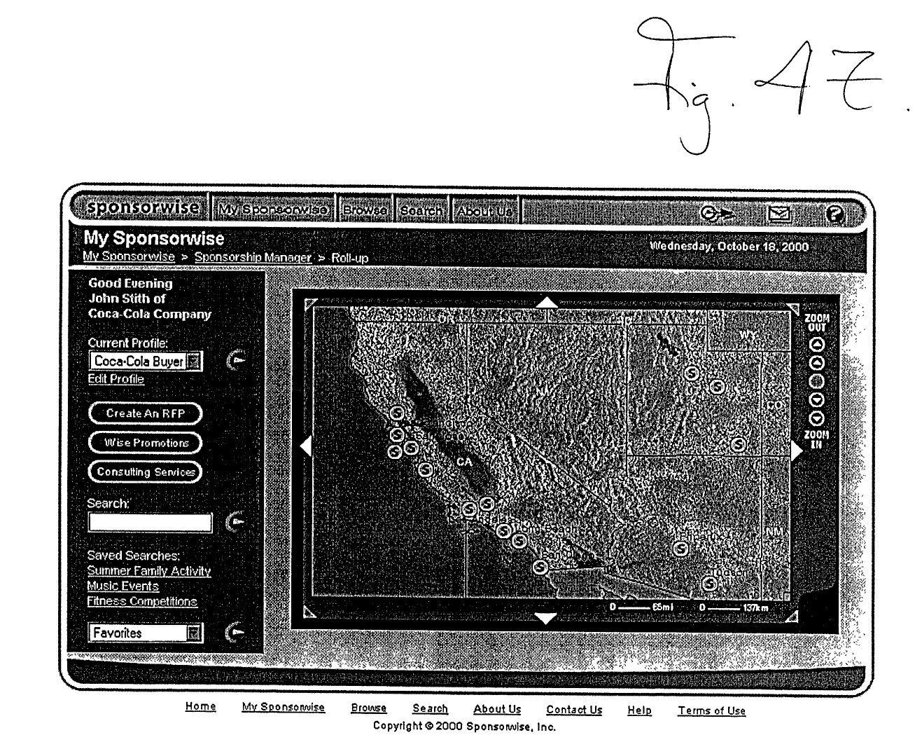

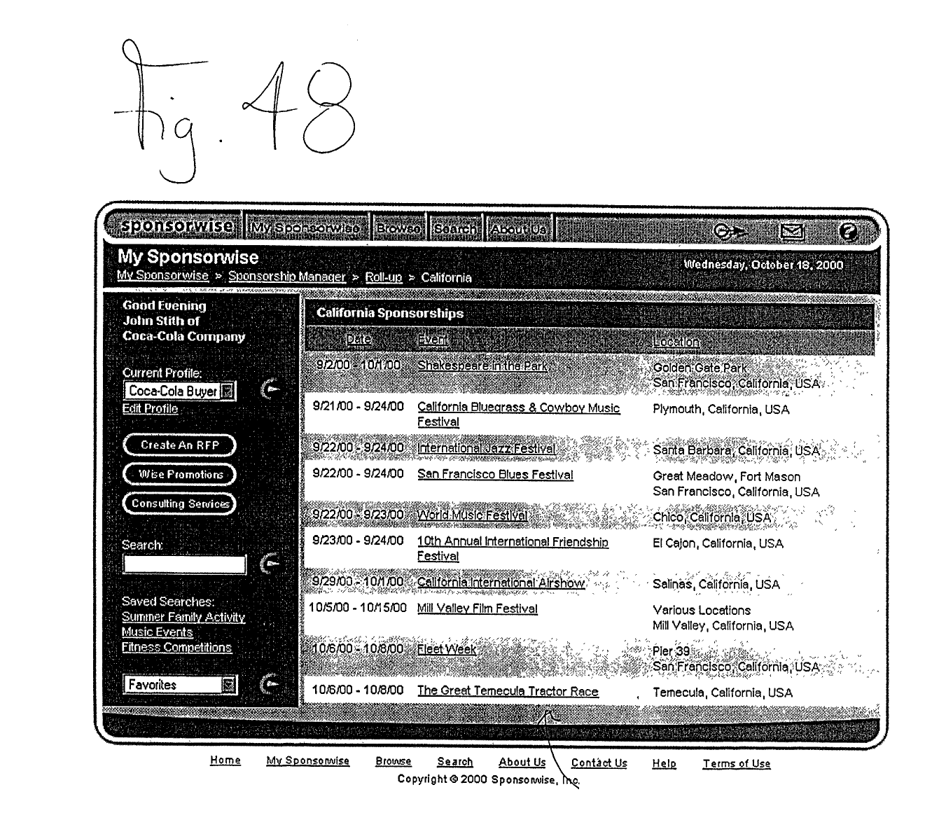

FIG. 46 presents a feature of the invention that may prove especially valuable for persons within advertising or marketing departments of corportations. This screen shot depicts the “Corporate Management Tool,” which allows personnel within a company that seeks events to sponsor to efficiently organize, track and use information about their sponsorship efforts. FIG. 47 includes a map which organizes sponsored events geographically, while FIG. 48 lists events located in a particular region.

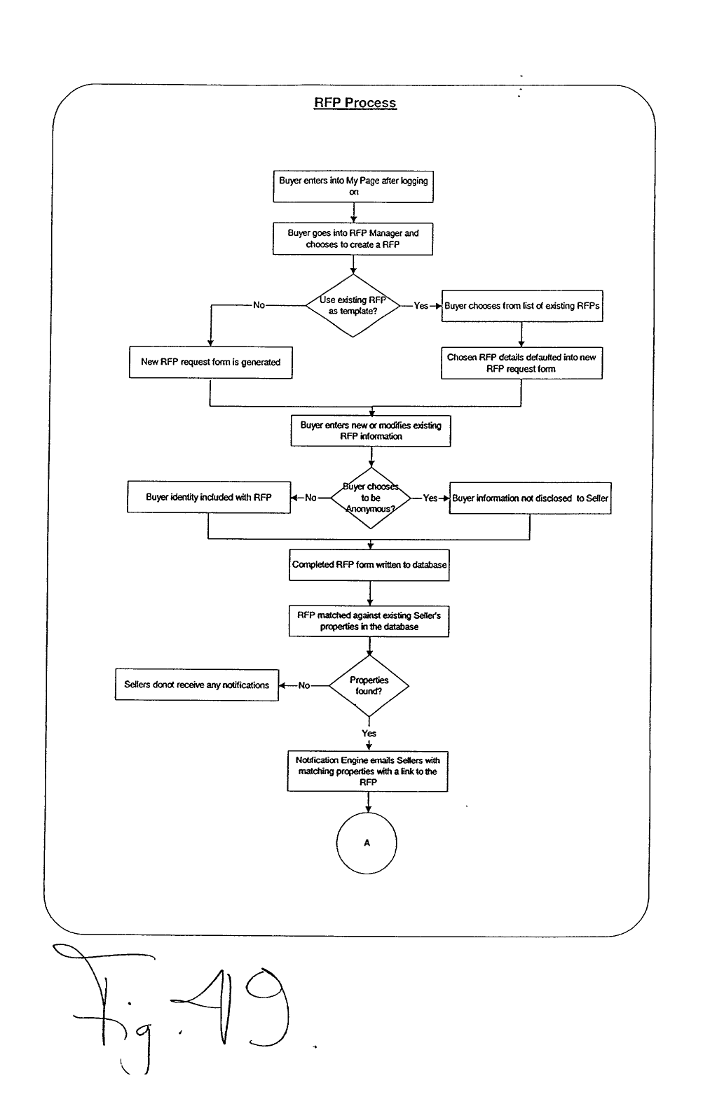

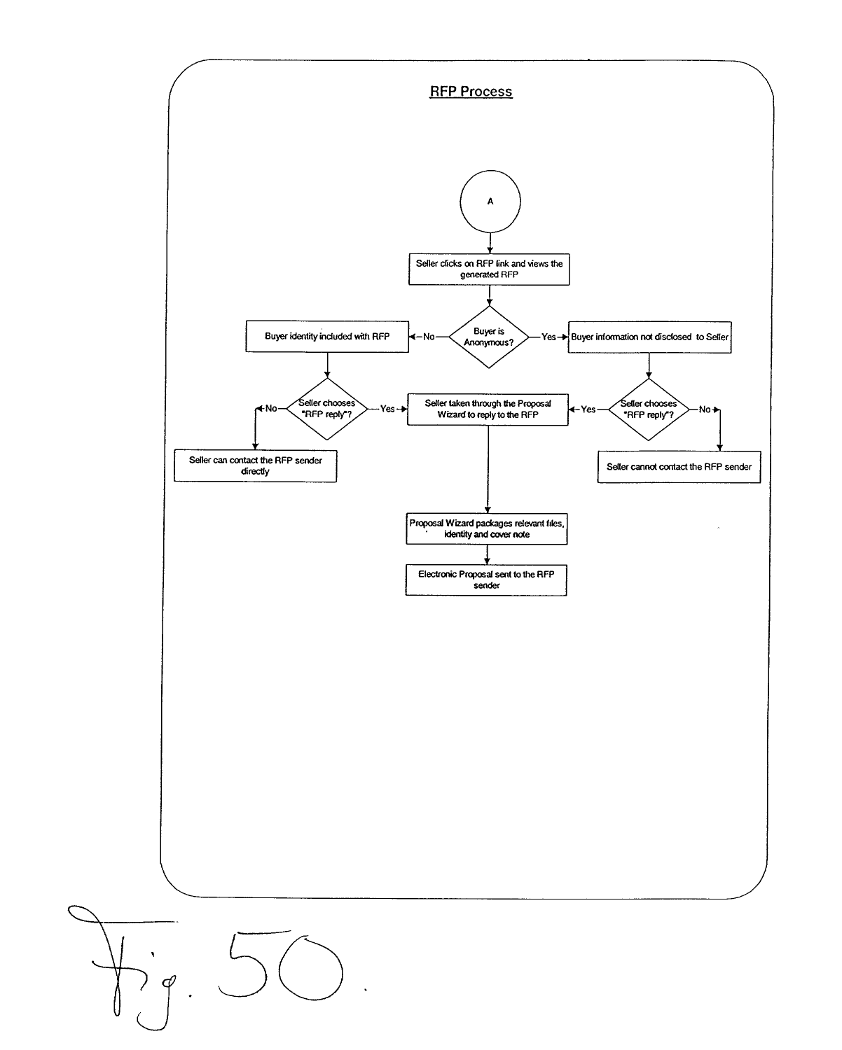

FIGS. 49 and 50 are flowcharts which illustrate the method of the invention concerning the RFP process.

### Appendices

This Specification includes two Appendices, identified as “A” and “B,” which contain more detailed information concerning various embodiments of the present invention. Appendix A, which follows the Abstract of the Disclosure and Sequence Listing, contains pages A-1 through A-13. Appendix B, which follows Appendix A, contains pages B-1 through B-11. Both of these Appendices are intended to form part of the disclosure of the present invention.

### Conclusion

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for implementing the invention that have been disclosed above are intended to educate the reader about preferred embodiments of the invention, and are not intended to constrain the limits of the invention or the scope of Claims.

### Appendix A

### &

### Appendix B

### BACKGROUND

Sponsorwise is developing a common platform that will act as a single point showcase for the players in the event sponsorship arena, which will be accessible to a wide range of Event Managers and Sponsors.

Given the scope of the endeavor and financial constraints, the project will be implemented in phases. The development methodology will be as follows:

Phase I implementation will provide basic features to the site. Subsequent releases will build on this foundation to provide enhanced functionality.

The Requirement analysis and architecture implementation will be done concurrently, given the tight schedule for Phase I.

To whatever extent possible, existent products/technologies that can be scaled up to meet future requirements will be used for the Phase I launch.

The creative design and development of the pages will be done by MentalModels based on the specifications sent by the Zeneb and Sponsorwise teams.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method comprising the steps of:
receiving data concerning an event;
organizing said data concerning an event into a sponsored event management database;
generating an event browser display; said event browser display including said data concerning said event; and
presenting said event browser display to a user.

2. A method as recited in claim 1, in which said event browser display is disseminated to said user via the Internet.

3. A method as recited in claim 1, in which said user is an event sponsor who utilizes said event browser display to view information concerning said event.

4. A method as recited in claim 1, in which said user is an event sponsor who utilizes said event browser display to conduct searches for a multiple listing of events.

5. A method comprising the steps of:
receiving data concerning a sponsor;
organizing said data concerning said sponsor into a sponsor management database;
generating a sponsor browser display; said sponsor browser display including said data concerning said sponsor; and
presenting said sponsor browser display to a user.

6. A method as recited in claim 5, in which said sponsor display is disseminated to said user via the Internet.

7. A method as recited in claim 4, in which said user is a property owner who utilizes said sponsor browser display to view information concerning said sponsor.

8. A method as recited in claim 4, in which said user is an event sponsor who utilizes said event sponsor display to conduct searches using a multiple listing of events.

9. A method comprising the steps of:
receiving a request for proposal from a sponsor;
presenting said request for proposal from said sponsor in an RFP management database;
generating an RFP display; said display including said request for proposal; and
presenting said RFP display to a user.

10. A method as recited in claim 9, in which said RFP display is disseminated to said user via the Internet.

11. A method as recited in claim 9, in which said user is a property owner who utilizes said RFP display to view information concerning said sponsor.

12. A method as recited in claim 11, including the additional step of:
offering said property owner an opportunity to create and to submit a sponsorship proposal to said sponsor.

13. A method as recited in claim 12, including the additional step of:
offering said sponsor an opportunity to contact said property owner regarding said sponsorship proposal.

14. A method as recited in claim 12, including the additional step of:
offering said sponsor an opportunity to accept said sponsorship proposal.

15. A method as recited in claim 9, including the additional step of:
allowing a user to view a listing of discounted properties.

16. A method comprising the steps of:
organizing data concerning a plurality of events sponsored by a sponsor into a customized sponsorship tool database;
generating a customized sponsorship tool browser display; said customized sponsorship tool display including said data concerning said plurality of events sponsored by said sponsor; and
presenting said customized sponsorship tool display to said sponsor.

17. A method as recited in claim 9, including the additional step of:
targeting an RFP by manually selecting a specific property owner.
